(19) United States
(12) Patent Application Publication
(10) Pub. No.: US 2023/0301457 A1
(43) Pub. Date: Sep. 28, 2023

(54) POUR OVER DRIPPER KIT FOR PREPARING A BEVERAGE

(71) Applicant: Spresso Novo Cap Ltd., Tel-Aviv (IL)

(72) Inventor: Yishai ASHLAG, Tel Aviv (IL)

(73) Assignee: Spresso Novo Cap Ltd., Tel-Aviv (IL)

(21) Appl. No.: 18/009,370

(22) PCT Filed: Jun. 15, 2021
(86) PCT No.: PCT/IL2021/050722

§ 371 Date: Dec. 9, 2022

Related U.S. Application Data
(60) Provisional application No. 63/121,934, filed on Dec. 6, 2020.
(60) Provisional application No. 63/038,932, filed on Jun. 15, 2020.

(51) Int. Cl. A47J 31/02; A47J 31/44; B65D 85/804

(52) U.S. Cl. CPC A47J 31/02; A47J 31/446; B65D 85/8043

(57) ABSTRACT

A pour over dripper kit for extracting a beverage through a single use capsule and into a vessel includes a water tank and a capsule holder. The water tank includes a base surface formed with a plurality of nozzles extending downwardly from said base surface and is configured receive a liquid and controllably dispense the liquid for preparing the beverage. The capsule holder fixedly engages the water tank to support the single use capsule under the base surface. The capsule holder includes at least one bottom opening through which the beverage is extracted. The plurality of nozzles are sized and positioned to pierce the single use capsule and to direct flow of the liquid into the single use capsule with gravitational flow.

### RELATED APPLICATION/S

This application claims the benefit of priority of U.S. Provisional Pat. Application No. 63/038,932 filed on Jun. 15, 2020 and to U.S. Provisional Pat. Application No. 63/121,934 filed on Dec. 6, 2020, the contents of both of which are incorporated herein by reference in their entirety.

### FIELD AND BACKGROUND OF THE INVENTION

The present invention, in some embodiments thereof, relates to a pour over dripper for manually preparing a beverage and, more particularly, but not exclusively, to a single use capsule for use with a pour over dripper kit.

Pour over coffee drippers for manually preparing filtered coffee are known. The dripper typically includes a filter and a frame to hold the filter over a glass, mug, cup, vacuum flask or carafe. The filter may be a reusable stainless steel/plastic filter and/or may require a paper filter. Ground coffee is manually inserted into the filter prior to use. While preparing coffee, it is generally advised to slowly pour preheated water over the coffee in a spiral motion, let the water drip through the filter, pause and then repeat until all the water for preparing the coffee is used up. A dedicated vessel with a long thin spout is typically used to pour the preheated water over the coffee to assist in manually controlling the rate of the pouring. In this manner, the preheated water passes through the grounded coffee without accumulating in the filter. This gradual pouring process provides properly extracting the rich flavor of the coffee while avoiding over brewing.

Disposable pour over coffee bags are also known. A disposable pour over coffee bag typically includes a paper filter prepackaged with a serving of grounded coffee and a paper/plastic frame attached to the filter. The frame is designed to stabilize the filter including the grounded coffee in a cup or mug. When preparing the coffee, a user is required to open the filter to expose the grounded coffee, mount the bag with the paper frame on a mug or cup and pour preheated water over the grounded coffee. A same process of slowly pouring preheated water over the coffee in a spiral motion, letting the water drip through the filter, pausing and then repeating until all the water for preparing the coffee is used up is recommended in order to avoid spoilage of the coffee. A dedicated vessel with a long thin spout is typically used to pour the preheated water over the coffee bag.

Helen of Troy Limited of Texas USA offers a pour over coffee maker with water tank under the brand name OXO®. The pour over coffee maker is disclosed in www(dot)oxo(dot)com/categories/coffee-tea/pour-over-coffee-maker-with-water-tank(dot)html#. The coffee maker is disclosed to include an auto-drip tank with a defined hole pattern for controlling flow rate and for evenly distributing the water over the coffee grounds.

### SUMMARY OF THE INVENTION

According to an aspect of some embodiments of the present invention, there is provided a pour over dripper kit configured to be operated with a single use capsule that is prepackaged with a beverage ingredient, e.g. grounded coffee. The single use capsule may optionally and preferably be a moisture and air impermeable receptacle that both preserves the beverage ingredient and also avoids any mess associated with measuring out and spooning the beverage ingredient. In this manner, a beverage may be easily prepared on demand with fresh ingredients. According to some example embodiments, the kit and single use capsule are configured for preparing a beverage manually without an electrically powered machine, and without the need to manually regulate the rate and/or distribution at which the liquid is added to the kit.

Optionally and preferably, the pour over dripper kit includes a water tank that provides pouring all the liquid for preparing the beverage in one go. According to some example embodiments, regulation of the rate and spatial distribution of the flow is regulated with a plurality of nozzles that extend out from a base of the water tank and direct the liquid into the single use capsule. The spatial distribution flow rate may be achieved without the need for a consumer to add the liquid to the water tank in a spiral motion and without the need to use a dedicated vessel with a long thin spout. Furthermore, this flow rate is configured to be actuated with gravitational flow and without requiring pressurized flow of the liquid through the single use capsule. Rather, liquid, e.g. pre-heated water is added to the water tank and the plurality of nozzles control the flow rate out of the water tank as well as the spatial distribution of the liquid in the single use capsule. Optionally and preferably. The pour over dripper, according to some embodiments, is manually operated with no machine or electric intervention and the water is introduced into and through the single use capsule by gravity only and without the use of pumps. According to some example embodiments, the single use capsule and kit are configured for manually brewing coffee with preheated water.

According to some example embodiments, the pour over dripper kit is configured for multiple use, e.g. is configured to be reused multiple times. The single use capsule (or the capsule) may be a single brew capsule or a multiple brew capsule. To prepare a beverage, e.g. coffee, the single use capsule may be added to the pour over dripper kit and a liquid ingredient, e.g., preheated water may be added to the kit. An additional beverage may be prepared based on replacing the capsule with a new capsule. According to some example embodiments, the pour over dripper kit includes a capsule mounting element that provides a fluid connection between the water tank and the single use capsule with which water from the water tank may be directed or drained through the single use capsule. According to some example embodiments, the capsule mounting element provides replaceably connecting single use capsules to the pour over kit.

In some example embodiments, the pour over dripper kit is configured for piercing an array of holes in the capsule that controllably directs the liquid ingredient therethrough. Alternatively, the capsule may include a plurality of preformed holes and the preformed holes are configured to regulate a rate at which a liquid penetrates into the beverage ingredient stored in the capsule, e.g. grounded coffee.

According to some example embodiments, there is provided a pour over dripper kit configured for extracting a beverage through a single use capsule and into a vessel, the kit comprising: a water tank including a base surface formed with a plurality of nozzles extending downwardly from the base surface, the water tank configured for receiving a liquid and controllably dispensing the liquid for preparing the beverage for preparing the beverage; and a capsule holder configured to be fixedly engaged with the water tank and to support the single use capsule under the base surface while fixedly engaged, wherein the capsule holder includes at least one bottom opening through which the beverage is extracted; wherein the plurality of nozzles are sized and positioned to pierce the single use capsule and to direct flow of the liquid into the single use capsule with gravitational flow while the water tank is engaged with the capsule holder.

Optionally, the plurality of nozzles is configured to regulate rate of flow through the single use capsule to a flow rate of 1.3-1.6 grams of liquid per second.

Optionally, the capsule holder comprises a seat with a structural feature configured to repeatedly form a liquid impermeable seal with a flange of the single use capsule, the flange extending outwardly from a side wall of the single use capsule.

Optionally, the kit further comprises at least one from a group consisting of a gasket mounted on the seat and an elastic or elastomer material coated on the seat and configured to provide the liquid impermeable seal with the single use capsule.

Optionally, the water tank includes an air vent through which air in the single use capsule can escape as said liquid is directed into the single use capsule.

Optionally, the kit further comprises a connecting element configured to connect the capsule holder to the water tank housing with a removable connection.

Optionally, the kit further comprises a water tank housing configured to house the water tank; and a stand configured to support the water tank housing at a defined height.

Optionally, the capsule holder includes a piercing structure configured for rupturing a bottom surface of the single use capsule through which the beverage is to be extracted.

Optionally, the capsule holder includes a capsule housing and an outer housing wherein the capsule housing is fitted into the outer housing with a slidable connection and wherein the outer housing includes a plug configured to plug the at least bottom opening.

Optionally, a lower rim of the water tank is configured to push outer housing downwards to release the plug as the capsule holder is being mounted onto the water tank housing based on the slidable connection.

Optionally, the plurality of nozzles is configured to regulate flow of water into the single use capsule including grounded coffee beans for brewing coffee.

According to some example embodiments, there is provided a single use capsule adapted for containing a beverage ingredient for use in making a beverage with a pour over dripper kit, the single use capsule comprising: a cylindrical side wall encompassing a volume for containing the beverage ingredient and defining an upper opening encompassed by an upper edge of the cylindrical side wall through which a liquid is configured to be received and a lower opening encompassed by a lower edge of the cylindrical side wall through which the beverage is configured to be extracted; a flange extending outwardly from the upper edge of the cylindrical side wall; a filter at least partially enclosed in the single use capsule and configured for filtering the beverage extracted through the lower opening; and an upper sealing membrane welded to the flange and configured to seal a top of the single use capsule, the upper membrane being configured for being pierced during preparation of the beverage.

Optionally, a bottom face of flange includes a sealant configured to form a liquid sealed connection with a surface on which the flange is mounted.

Optionally, the single use capsule further comprises a lower sealing membrane configured to seal the lower opening and for being manually removed prior to use with the pour over dripper kit.

Optionally, the filter is sized to extend out from the lower opening and wherein a portion of the filter that extends out is 10% - 50% of a height of the filter.

Optionally, the filter is welded to the cylindrical side wall, the flange and/or a rim extending inwardly from the lower edge of the cylindrical side wall.

Optionally, the filter is a pouched shaped and is formed from pliable material.

Optionally, the beverage ingredient is ground coffee beans.

According to some example embodiments, there is provided a pour over dripper housing configured for use with a single use capsule, the pour over dripper housing comprising: a collar including a structural feature configured to repeatedly form a liquid impermeable seal with single use capsules including a beverage ingredient; a surrounding wall extending upwards from the collar; an opening distal from the collar defined by the surrounding wall, wherein the opening is configured for receiving the liquid for preparing a beverage with a single use capsule; and a support structure configured to support the collar over a glass, mug, cup, vacuum flask or carafe.

Optionally, the collar includes a gasket fitted thereon or is coated with an elastic or elastomer material.

Optionally, the support structure is a flange shaped base extending outwards from the collar.

According to some example embodiments, there is provided a single use capsule for use with a pour over dripper housing, the single use capsule comprising: one or more walls defining a volume configured to contain a beverage ingredient; an array of preformed inlet holes through which a liquid is configured to be received in the volume; and an array of preformed outlet holes through which a prepared beverage is configured to be extracted from the volume, wherein the array of preformed outlet holes is other than the array of preformed inlet holes and displaced therefrom.

Optionally, one or more walls includes a cylindrical wall extending from a base wall and wherein the array of preformed inlet holes is spread across one or more of the base wall and the cylindrical wall.

Optionally, the array of preformed outlet holes is on a lid wall opposite the base wall, wherein the lid wall is one of the one or more walls.

Optionally, the array of preformed outlet holes is an outlet filter positioned within the volume, and further comprising an outlet through which the prepared beverage is expelled out from the single use capsule, wherein the outlet filter extends along at least a portion of a height of the single use capsule, and wherein the outlet filter has a cylindrical shape defining an inner volume and wherein the outlet extends from the inner volume of the outlet filter.

Optionally, the array of preformed inlet holes is at least one inlet filter positioned within the volume, wherein the at least one inlet filter is positioned to receive liquid through at least one inlet on one or more walls of the single use capsule, wherein the inlet filter extends along at least a portion of a height of the single use capsule.

Optionally, the array of preformed outlet holes is an outlet filter positioned within the volume, and further comprising an outlet through which the prepared beverage is expelled out from the single use capsule, wherein the outlet filter extends along at least a portion of a height of the single use capsule and wherein the outlet filter has a cylindrical shape defining an inner volume and wherein the outlet extends from the inner volume of the outlet filter.

Optionally, the array of preformed inlet holes is configured to regulate flow of water into the single use capsule including grounded coffee beans for brewing coffee.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an example pour over dripper kit in accordance with a first aspect of some example embodiments;

FIGS. 2A and 2B are a perspective and top view of an example capsule holder, both in accordance with a first aspect of some example embodiments;

FIGS. 3A and 3B are an example capsule holder shown without and with a capsule housed therein, both in accordance with a first aspect of some example embodiments;

FIGS. 4A, 4B and 4C are a perspective, side and top view of an example water tank in accordance with a first aspect of some example embodiments;

FIGS. 5A and 5B are a side and cross sectional view of an example water tank in accordance with a first aspect of some example embodiments;

FIG. 6 is another perspective view of an example pour over dripper kit in accordance with a first aspect of some example embodiments;

FIGS. 7A and 7B are a side and cross sectional view of an example pour over dripper kit in accordance with a first aspect of some example embodiments;

FIGS. 8A and 8B are cross sectional views of an example capsule holder in a sealed and open flow configuration respectively, both in accordance with a first aspect of some example embodiments;

FIGS. 9A, 9B and 9C are perspective, side and cross sectional view of an example capsule in accordance with a first aspect of some example embodiments;

FIG. 10 is a simplified flow chart of an example method to prepare a beverage ingredient with a pour over dripper kit in accordance with a first aspect of some example embodiments;

FIGS. 11A and 11B are respectively an example pour over dripper kit and an example pour over dripper system, both in accordance with a second aspect of some example embodiments;

FIG. 12 is an example assembled pour over dripper system in use in accordance with a second aspect of some example embodiments;

FIGS. 13A and 13B are respectively a perspective view and a bottom view of an example sealed capsule in accordance with a second aspect of some example embodiments;

FIGS. 14A, 14B and 14C are respectively a perspective view of an example capsule with the upper seal removed, the example capsule with both the upper seal and the filter removed and the example capsule shown without the upper seal and the lower seal and the filter, all in accordance with a second aspect of some example embodiments;

FIGS. 15A and 15B are respectively side and cross-sectional views of an example sealed capsule in accordance with a second aspect of some example embodiments;

FIGS. 15C and 15D are respectively side and cross-sectional views of an example capsule with its filter extending through an exposed opening in its bottom face in accordance with a second aspect of some example embodiments;

FIGS. 16A, 16B, 16C and 16D are perspective, side top and bottom views of an example water tank in accordance with a second aspect of some example embodiments;

FIGS. 17A and 17B are respectively a perspective and a detailed view of the example water tank, in accordance with a second aspect of some example embodiments;

FIG. 18A is a perspective view of an example dripper housing in accordance with a second aspect of some example embodiments;

FIG. 18B is a perspective view of an example dripper housing and capsule including a locking feature in accordance with a second aspect of some example embodiments;

FIGS. 19A and 19B are respective a blow up view of an example pour over dripper system and a pierced capsule, both in accordance with a second aspect of some example embodiments;

FIG. 20 is a simplified flow chart of an example method to prepare a beverage with a pour over dripper kit in accordance with a second aspect of some example embodiments;

FIG. 21 is an example capsule configured for use with a pour over beverage dripper in accordance with a third aspect of some example embodiments;

FIG. 22 is an example capsule with an enclosed filter also configured for use with a pour over beverage dripper in accordance with a third aspect of some example embodiments;

FIG. 23 is an example capsule with a plurality of enclosed filters also configured for use with a pour over beverage dripper in accordance with a third aspect of some example embodiments;

FIG. 24 is a perspective cross sectional view of an example capsule and an example pour over dripper housing in accordance with a third aspect of some example embodiments;

FIG. 25 is a perspective cross sectional view of an example capsule including an enclosed filter and an example pour over dripper housing in accordance with a third aspect of some example embodiments; and

FIG. 26 is a perspective cross sectional view of an example capsule including a plurality of enclosed filters and an example pour over dripper housing in accordance with a third aspect of some example embodiments.

### DESCRIPTION OF SPECIFIC EMBODIMENTS OF THE INVENTION

The present invention, in some embodiments thereof, relates to a pour over dripper for manually preparing a beverage and, more particularly, but not exclusively, to a pour over dripper including a single use capsule and a pour over capsule holder.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

According to some example embodiments, the pour over dripper kit includes a water tank that is optionally and preferably configured to hold all the liquid for preparing the beverage in one go as well as a capsule holder configured to support a single use capsule under the water tank. Optionally, the single use capsule has a side wall that has a truncated cone shape tapering toward a base surface. The single use capsule includes an upper surface facing the water tank and a bottom surface facing the vessel. Optionally, the beverage ingredient is added through the open upper surface that is subsequently sealed with a sealing membrane.

According to some example embodiments, the water tank includes a base that is formed with a plurality of funnel shaped nozzles that extend downwardly from the base. The plurality of nozzles may provide controllably directing flow of water through the capsule. The base of the water tank may be sized to substantially match a diameter of the capsule. The plurality of nozzles may be funnel shaped, e.g. tapering distal from the base. In some example embodiments, the water tank locks onto the capsule holder. Locking may be with a bayonet mount connector, screw thread connection, snap connection and/or friction fit connection. Optionally, as the water tank locks into place, the plurality of nozzles are brought in contact with an upper surface of the capsule with force needed to pierce the surface or sealing membrane of the capsule. Optionally and preferably, the upper surface of the capsule has a larger diameter than that of the base surface. The larger diameter may accommodate the plurality of nozzles that provide the desired spatial distribution of flow as well as the desired flow rate, both based on gravitational flow and without requiring pressurized flow of the liquid through the capsule.

According to some example embodiments, the plurality of nozzles are configured to actuate a flow rate of 1-2 grams of liquid (e.g. water) per second and preferably 1.3-1.6 grams per second through the capsule. This flow rate is configured to be actuated with gravitational flow and without requiring pressurized flow of the liquid through the capsule. Rather, liquid, e.g. pre-heated water is added to the water tank and the plurality of nozzles control the flow rate out of the water tank as well as the spatial distribution of the liquid in the capsule. Optionally and preferably, the plurality of nozzles are distributed across a base of the water tank to provide a desired spatial distribution of the liquid through the beverage ingredient stored in the capsule. Optionally, a substantially even spatial distribution is desired and may be achieved without the need to add the liquid in a spiral motion to the water tank. In some example embodiments, the plurality of nozzles include 15 - 40 nozzles, e.g. 20-25 nozzles or 30-40 nozzles. Optionally and preferably, the diameter of one or more of the plurality of nozzles at the outlet is 0.5 mm - 0.9 mm, e.g. 0.6 mm - 0.7 mm and/or 0.65 mm - 0.7 mm. In some example embodiments, all of the plurality of nozzles have a same outlet diameter. In other example embodiments, the outlet diameter of at least one of the plurality of nozzles may be selected to be different than the others based on its location.

According to some example embodiments, the water tank includes one or more air vents through which air from the capsule may escape as liquid from the water tank is streamed through the capsule. According to some example embodiments, the air vents prevent clogging of the capsule during brewing and over brewing due to the clogging.

In some example embodiments, a single use capsule dedicated for use with the pour over dripper kit of the first aspect includes a base and a cylindrical side wall extending from the base and defining an upper opening through which the liquid is received. According to some example embodiments, the capsule includes a flange that extends outwardly from an upper edge of the cylindrical side wall. An outer diameter of the flange may be for example 6-8 cm. Optionally, the upper opening is approximately 4-6 cm in diameter with a flange that may be for example 0.5-1.5 cm wide. Optionally, the flange provides a surface for forming a liquid impermeable seal between the capsule and the pour over dripper kit so that all the liquid from the water tank is directed through the capsule during preparation of the beverage. Optionally, a portion of the flange, e.g. lower surface and/or upper surface is coated with an elastic or elastomeric material to improve seal of the capsule in the kit.

Optionally and preferably, the cylindrical side wall is formed from aluminum sheet material. Optionally and preferably, the upper opening is sealed with an upper sealing membrane welded to the flange. The upper sealing membrane may be configured for being pierced with the plurality of nozzles during preparation of the beverage. Optionally and preferably, the upper sealing membrane is an aluminum foil. In some example embodiments, the capsule houses a filter through which the beverage is extracted. Optionally, the filter is cup or pouch shaped. Optionally, the filter is welded to the flange and/or an upper edge of the cylindrical side wall of the capsule. Filters enclosed within the capsule may be formed with a same or different material than the capsule.

According to a first aspect of some example embodiments, the capsule holder includes a capsule housing configured to receive a single use capsule, a connecting element configured to connect the capsule holder to the water tank housing with a removable connection and optionally a handle for manipulating the capsule holder. Optionally and preferably, the capsule holder includes a piercing structure configured for rupturing a bottom surface of the capsule through which the beverage is to be extracted and a plurality of through going holes through which the beverage is extracted. Optionally and preferably, the piercing element is configured to forcibly engage and pierce the bottom surface of the capsule as the capsule holder is connected to the water tank housing, e.g. with a locked engagement.

In some example embodiments of the first aspect, the capsule holder includes a plug to prevent leakage through the capsule holder while removing or connecting the capsule holder to the water tank housing. The plug may be released while preparing a beverage based on manual manipulation of the capsule holder.

In some example embodiments of the first aspect, the pour over dripper kit includes the water tank and the capsule holder and additionally includes a water tank housing for housing the water tank and a stand for supporting the water tank housing at a defined height above a surface on which it stands. Optionally and preferably, the stand includes a tray on which a vessel, e.g. cup may be positioned below the water tank housing to receive the extracted beverage.

According to a second aspect of some example embodiments, the pour over dripper kit includes a capsule holder integrated with a supporting structure configured to support the kit on or over the vessel that receives the beverage and the water tank is configured to be mounted over the capsule holder. Optionally, the water tank is connected to the capsule holder with a bayonet connector, screw connection or snap connection. Optionally and preferably, the capsule holder is configured to expose a bottom surface of a single use capsule through which a beverage is extracted.

In some example embodiments of the second aspect, a single use capsule dedicated for use with the pour over dripper kit of the second aspect additionally includes a lower opening through which the beverage is extracted. Optionally and preferably, the lower opening is sealed with a lower sealing membrane that is configured to be pulled off prior to use, e.g. prior to inserting into the pour over dripper kit and thereby expose the opening. Optionally, the lower sealing membrane is an aluminum foil. Optionally, the lower sealing membrane is a cap that may connected with a screw connection or a snap connection. Optionally, the lower opening is approximately 3-5 cm in diameter.

Optionally and preferably, the capsule includes a flange that is pressed between a surface of the water tank and the capsule holder and the pressing provides a liquid impermeable seal so that during preparation of the beverage, all the liquid in the water tank is extracted through the capsule. Optionally, elastic or elastomeric material between the flange and a surface of the capsule holder below the flange facilitates the liquid impermeable seal. Optionally, an outer diameter of the flange is 6-8 cm and a width of the flange is 0.5 cm -1 cm wide. Optionally and preferably, the cylindrical side wall is formed from aluminum sheet material. Optionally, the aluminum sheet material is coated with a lacquer. Optionally and preferably, the lower sealing membrane is an aluminum foil.

According to some example embodiments of the second aspect, the capsule houses a filter and the filter is sized to extend through the lower opening during preparation of the beverage. For example, the filter may have a height that is 10% - 50% greater than that of the capsule. Optionally, protrusion of the filter through the opening increases surface area through which the beverage may be extracted from the filter and may increase a rate at which the beverage is extracted.

According to a third aspect of some example embodiments a pour over dripper includes a pour over dripper housing on which a capsule is configured to be mounted. According to some example embodiments, the flow into and out of the beverage ingredient, e.g. ground coffee and/or other ingredient is regulated by the capsule. Optionally, the pour over dripper housing is funnel shaped and the capsule is configured to be attached to the tapered opening of the funnel shaped housing. According to some example embodiments, the pour over dripper housing additionally includes a structural feature that provides positioning the pour over dripper housing on or over a glass, mug, cup, vacuum flask or carafe. The structural feature may be flange shaped base extending around the pour over dripper housing, e.g. around the tapered opening.

According to some example embodiments of the third aspect, the capsule is a rigid structure defining an enclosure that includes a plurality of preformed holes through which a liquid can penetrate into the capsule, contact the beverage ingredient and then flow out of the capsule. The plurality of holes is designed to regulate the flow of the liquid through the capsule and through the beverage ingredient contained therein.

Optionally and preferably, the capsule includes a flange extending out from an external surface of the capsule. The flange, e.g. a flange like rim is configured to fit with a sealed connection into the pour over dripper housing. Optionally, the capsule is snap fitted or screw fitted onto the pour over dripper housing. Optionally, the flange, a portion of the flange or a coating on the flange is an elastic or flexible material that is configured to facilitate the sealed connection. The flange may be formed from a same or different material that the rest of the capsule. Optionally, the capsule may form a seal based on engagement with other elements of the capsule, e.g. engagement with a surrounding wall of the capsule. The capsule may be formed with aluminum for example with an aluminum sheet, e.g., in a drawing process or may be formed with a polymer material, e.g., in a molding process. Filters enclosed within the capsule may be formed with a same or different material than the capsule.

In some example embodiments, one of the capsule and the pour over dripper housing includes a piercing element that is manually activated based on fitting the capsule onto the housing. In some example embodiments, a portion of the capsule is configured to hang below the pour over dripper housing. In other example embodiments, the capsule is configured to be substantially contained within the pour over dripper housing.

### First Aspect of Some Example Embodiments

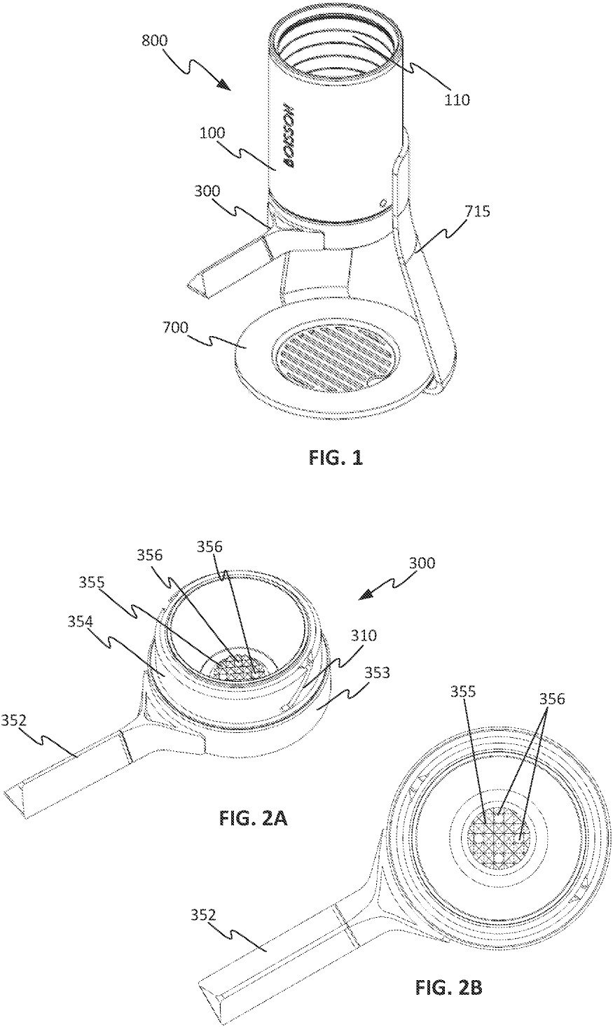

Reference is now made to FIG. 1 showing an example pour over dripper kit in accordance with a first aspect of some example embodiments. According to some example embodiments, a pour over dripper kit 800 includes a water tank housing 100 supported above a tray 700 with a stand 715 and a capsule holder 300. Optionally, water tank housing 100 houses a water tank that is removably connected to water tank housing 100. Optionally, a water tank housing 100 is not required and instead stand 715 is fixedly connected to water tank 110. Optionally, water tank housing 100 is a cylindrical shaped housing that is open at both ends. Optionally pour over dripper kit 800 includes a lid to cover the open end of water tank housing 100. To prepare a beverage, a single use capsule may be inserted into capsule holder 300 and capsule holder 300 with the single use capsule may be connected to water tank housing 100. Optionally and preferably, the connection between capsule holder 300 and water tank housing 100 is a liquid impermeably sealed connection so that all the liquid introduced into a water tank housed in water tank housing 100 may be directed through a capsule in capsule holder 300 through one or more opens formed in a base of the water tank.

According to some example embodiments, piercing of both an upper surface and a lower surface of the capsule housed in capsule holder 300 is affected as capsule holder 300 is mounted onto water tank housing 100. Once capsule holder 300 is connected to water tank housing 100, liquid for preparing the beverage introduced into water tank housing 100 seeps through the capsule housed in capsule holder 300 and through capsule holder 300 and into a vessel positioned over tray 700. The liquid extracted through capsule holder 300 is the beverage. In some example embodiments, the capsule includes grounded coffee, the liquid introduced into water housing 100 is preheated water and beverage extracted from capsule holder 300 is brewed coffee.

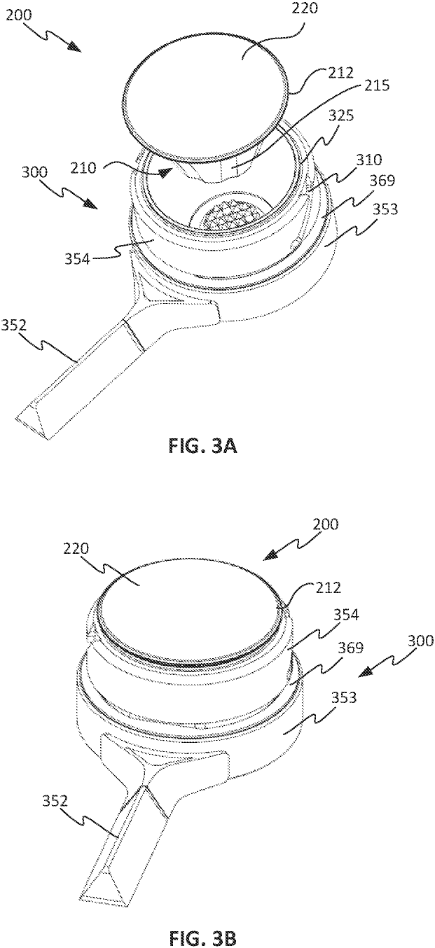

Reference is now made to FIGS. 2A and 2B showing a perspective and top view of an example capsule holder as well as to FIGS. 3A and 3B showing the example capsule holder shown without and with a capsule housed therein, both in accordance with a first aspect of some example embodiments. According to some example embodiments, capsule holder 300 includes an inner housing or capsule housing 354 fitted into an outer housing 353 and a handle 352 fixedly attached to outer housing 353. A capsule 200 may be received in inner housing 354. In some example embodiments, inner housing 354 may include a lower surface 355 that is jagged and/or that is formed with a plurality of protrusions, each configured to rupture a bottom surface of capsule 200 when capsule 200 is pushed against lower surface 355. Lower surface 355 may additionally include one or more through going holes 356 through which a beverage may be extracted from capsule holder 300.

Referring now to FIGS. 3A and 3B, in some example embodiments, capsule 200 is a closed receptacle containing a beverage ingredient. Optionally and preferably, capsule 200 is configured to provide a moisture and air impermeable seal to preserve the beverage ingredient contained therein. Capsule 200 may be shaped with cylindrical side wall 210 tapering toward a capsule base and an upper opening that is sealed with an upper sealing membrane 220. According to some example embodiments, a flange 212 extends outwardly from an upper edge of the cylindrical side wall 210 and provides a surface that can be supported on a seat 325 formed on an upper rim of inner housing 354. Optionally, a gasket may be positioned on seat 325 to provide a liquid sealed engagement. Optionally, a bottom face of flange 212 (opposite upper sealing membrane 220) includes a sealant defined to have properties, e.g. hardness and/or elasticity that is suitable for forming a liquid sealed connection with seat 325.

In some example embodiments, capsule holder 300 is connected to water tank housing 100, e.g. locked onto water tank housing 100 with one or more bayonet mount connectors. Slot(s) 310 of the bayonet mount connector(s) may be formed on an external surface of inner housing 354 is configured to engage with matching pin(s) on water tank housing 100. In other example embodiments, a screw connection or snap fit connection may be used in place of a bayonet mount connection.

According to some example embodiments, inner housing 354 is connected to outer housing 353 with a slidable connection that provides sliding outer housing 353 away from inner housing 353 against a resilient force. Optionally, outer housing 353 provides a plug for plugging opening 356. In some example embodiments, the plug blocks opening 356 in a neutral state of the resilient force and the plug is released based on pushing on a rim 369 of outer housing 353 with corresponding rim of water housing 100 as capsule holders is being fitted onto water tank housing 100 with bayonet connector 310.

According to some example embodiments, each of capsule holder 300 and water tank 100 are sized and configured to prepare a beverage with a capsule 200 containing a beverage ingredient. In some example embodiments, capsule 200 includes coffee grounds and kit 800 provides for manually brewing the coffee, e.g. without a coffee machine. Optionally, capsule 200 includes other or additional beverage ingredients, e.g. powdered milk, a sweetener, tea and/or cocoa. Kit 800 together with capsule 200 defines a pour over dripper system 500. Optionally and preferably, capsule 200 is sized to contain a quantity of beverage ingredient suitable for preparing a single serving of a beverage, e.g. a single cup. In some example embodiments, capsule 200 and/or contents within capsule 200 is suitable for preparing a double serving or more than two servings of a beverage, e.g. a pot of a beverage with multiple servings. Optionally and preferably, kit 800 is configured for multiple use. Multiple servings may be prepared with kit 800 by using a new capsule 200 for each additional serving.

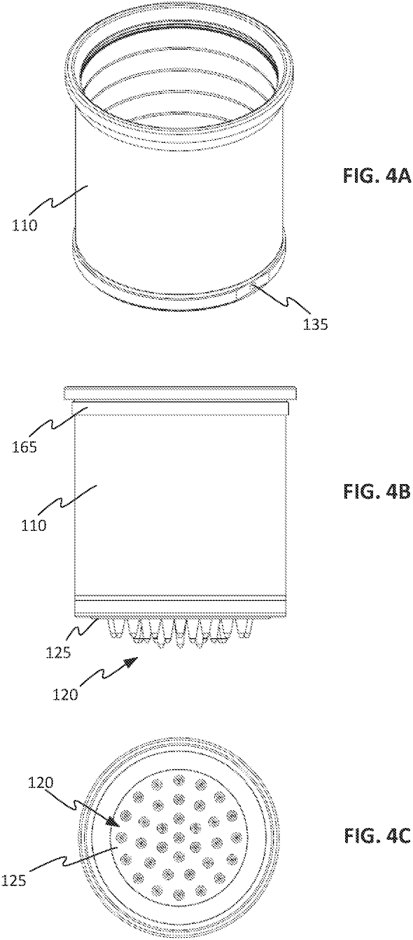

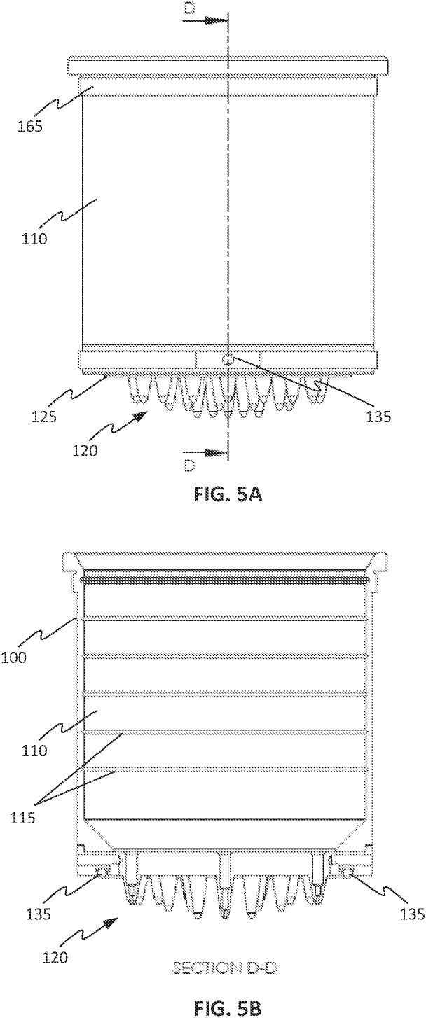

Reference is now made to FIGS. 4A, 4B and 4C showing a perspective, side and top view of an example water tank and to FIGS. 5A and 5B showing a side and cross sectional view of an example water tank, both in accordance with some example embodiments of the first aspect of. According to some example embodiments, water tank 110 is a removable tank that is fitted into a water tank housing 100. Optionally, water tank 110 and water tank housing 100 are integral and together constitute the water tank. Water tank 110 may include a cylindrically shaped wall 110 and a bottom surface 125. Optionally, an inner surface of water tank 110 may be marked with a plurality of engravings and/or ribs 115 configured to indicate liquid level of the liquid contained in the water tank. Optionally, an elastic or elastomeric band 165 may be fitted around the cylindrical wall for fitting water tank 110 in water tank housing 100 with a snug fitting to prevent movement of water tank 110 within water tank housing 100.

According to some example embodiments, a plurality and/or an array of nozzles 120 protruding downwardly below bottom surface 125 through which liquid stored in tank 110 may drip. Optionally nozzles 120 are shaped to taper distal from bottom surface 125, e.g. in the downward direction. In some example embodiments, nozzles 120 are integrally formed on bottom surface 125, e.g. in a molding process. The number, diameter, length and distribution pattern of nozzles 120 may be defined to provide a desired flow rate and pattern through capsule 200, e.g., of 1-2 grams per second and preferably 1.3-1.6 grams per second through the capsule. In some example embodiments, nozzles 120 are defined to have different lengths. The different lengths may provide a more even distribution of the liquid through the beverage ingredient within capsule 200. Based on the different lengths of nozzles 120, different locations within the volume of capsule 200 may receive liquid drops at different times. This may avoid forming a puddle in capsule 200 and over-brewing of the beverage due to the puddle, e.g. due to clogging. In some example embodiments, nozzles 120 in the center of bottom surface are defined to be longer than nozzles 120 along edges of bottom surface 125. The longer nozzles provide penetrating the center of the membrane that may optionally be recessed in relation to the edges. According to some example embodiments, nozzles 120 are configured to pierce upper sealing membrane 220 of capsule 200 when capsule holder 300 including capsule 200 is connected to water tank housing 100 housing water tank 110.

According to some example embodiments, water tank 110 includes one or more air venting holes 135 through which air within capsule 200 may escape as liquid is introduced into capsule 200 with nozzles 120. Air venting holes 135 preventing a clog in capsule 200 during brewing that may otherwise lead to over brewing of the beverage (e.g. coffee). Optionally and preferably, air venting holes 135 penetrate through a wall thickness of water tank 110 at a bottom portion of water tank 110 around nozzles 120 without penetrating into an inner volume of water tank 110.

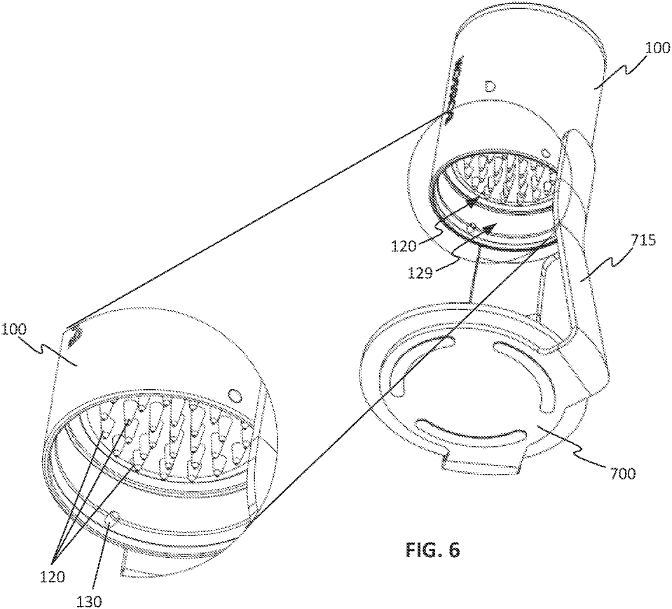

Reference is now made to FIG. 6 showing another perspective view of an example pour over dripper kit, in accordance with a first aspect of some example embodiments. According to some example embodiments, nozzles 120 are exposed through a bottom opening 129 of water tank housing 100 when water tank 100 is fitted into water tank housing 100. Optionally and preferably, nozzles 120 are recessed with respect to the bottom water tank housing 100 at a height that provides receiving a portion of inner housing 354 of capsule holder 300 (FIG. 3A). In some example embodiments, an inner surface of water tank housing 100 includes a pin 130 (or more than one pin) of a bayonet mount connector. Pin 130 and slot 310 in the capsule holder are the bayonet mount connector(s) for connecting capsule holder to water tank 100. Other types of connections, e.g. screw connection, snap connection may be used in place of the bayonet connector. As the capsule holder 300 is raised into water tank housing 100 with the bayonet mount connector(s), capsule 200 held within capsule holder 300 is forcibly engaged with nozzles 120. The forcible engagement pierces upper sealing membrane 220 and nozzles 120 penetrate into capsule 200.

According to some example embodiments, nozzles 120 are configured to actuate a flow rate of 1-2 grams per second and preferably 1.3-1.6 grams per second through capsule 201. Optionally and preferably, nozzles 120 are distributed across base 118 to provide a substantially even spatial distribution of the liquid through the beverage ingredient stored in capsule 201. In some example embodiments, nozzles 120 include 15-30 nozzles, e.g. 20-25 nozzles. Optionally and preferably, an outlet diameter of one or more of nozzles 120, e.g., diameter at its tapered end is 0.5 mm - 0.9 mm, e.g. 0.6 mm -0.7 mm and/or 0.65 mm - 0.7 mm. In some example embodiments, all nozzles 120 are selected to have a same diameter.

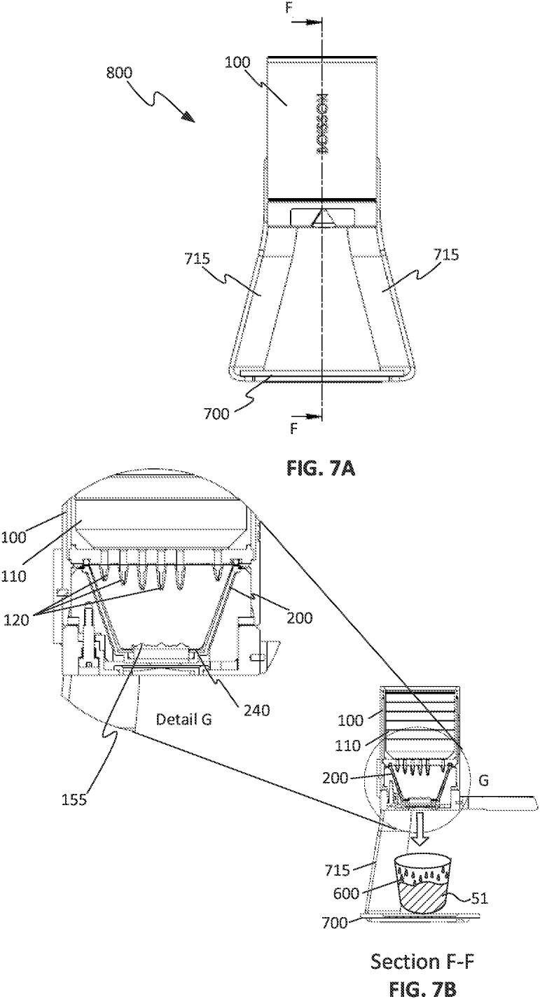

Reference is now made to FIGS. 7A and 7B is a side and cross sectional view of an example pour over dripper kit in accordance with a first aspect of some example embodiments. According to some example embodiments, when capsule 200 is within capsule holder 300 and capsule holder 300 is connected to water tank housing 100, upper sealing membrane 220 of capsule 200 is pierced with nozzles 120 and a bottom surface 240 of capsule 200 is pierced and/or ruptured with jagged surface and/or other piercing element 155. Once pierced, liquid in water tank 110 drips into capsule 200 for preparing, e.g. brewing the beverage. Beverage 51 extracted from capsule 200 drips into a vessel 600 that may be positioned on tray 700.

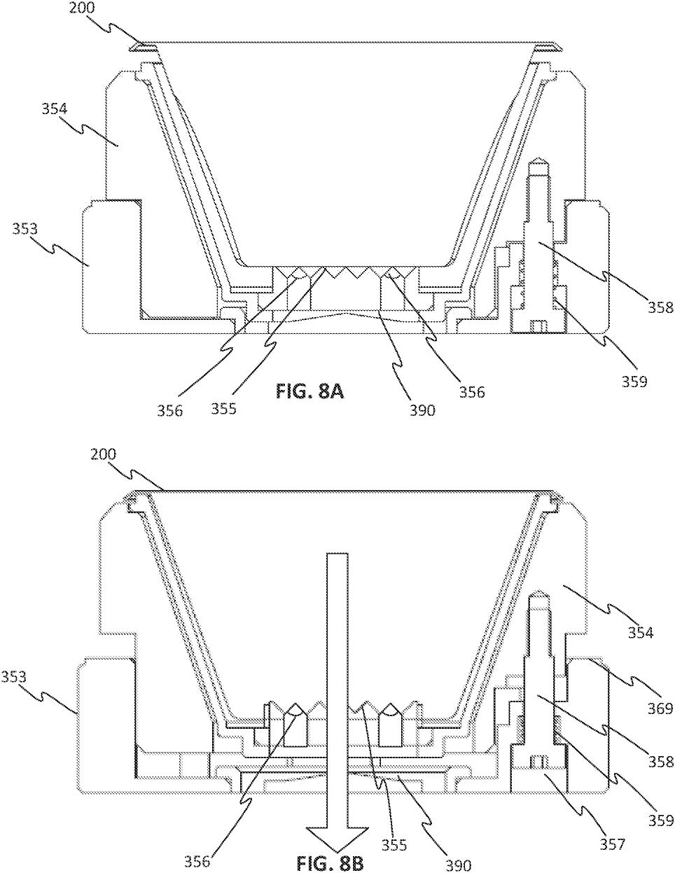

Reference is now made to FIGS. 8A and 8B showing cross sectional views of an example capsule holder in a sealed and open flow configuration respectively, both in accordance with a first aspect of some example embodiments. According to some example embodiments, inner housing 354 is connected to outer housing 353 with slidable pin 358 that slides through a bore 357 against a spring 359 as inner housing 354 and outer housing 353 move toward and away from one another. In a neutral state of spring 359, outer housing 353 is pressed against inner housing 354 and is configured to plug holes 356 through which the beverage is extracted. The plugged state is shown in FIG. 8A. Release of the plug may be achieved by lowering outer housing 353 in relation to inner housing 354. Outer housing 353 may be lowered based on rim 369 engaging water tank housing as capsule holder is mounted on water tank 100. A diameter of outer housing 353 is larger than a diameter of inner housing 354. Optionally and preferably, a diameter of inner housing 353 is sized to fit within water tank housing 100.

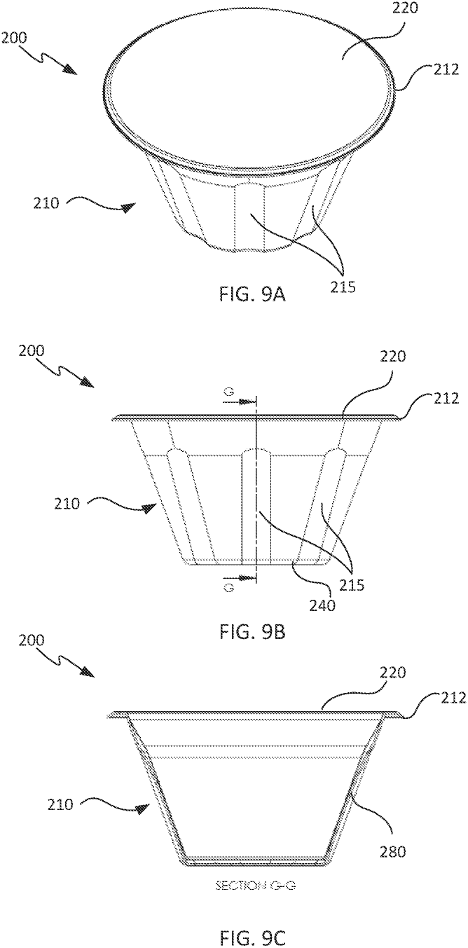

Reference is now made to FIGS. 9A, 9B and 9C showing perspective, side and cross sectional view of an example capsule in accordance with a first aspect of some example embodiments. In some example embodiments, capsule 200 includes an upper sealing membrane 220 cylindrical side wall 210, a flange 212 extending out from cylindrical side wall 210 and a base surface 240. Upper sealing membrane 220, lower sealing membrane 230 and cylindrical side wall 210 together define a closed receptacle configured for containing a beverage ingredient. Optionally and preferably the closed receptacle configuration provides a moisture and air impermeable seal to preserve the beverage ingredient contained in capsule 200. According to some example embodiments, capsule 200 additionally includes a filter 280 and the beverage is configured to be extracted through the filter in capsule 200.

In some example embodiments, cylindrical side wall 210 has a truncated cone shape tapering toward base surface 240. In some example embodiments, cylindrical side wall 210 includes a plurality of indentations 215 or protrusions that protrude into an inner volume of capsule 200. Optionally and preferably, cylindrical side wall 210 is aluminum sheet, e.g. with about 60 µm - 210 µm thickness. Optionally, the aluminum sheet is laminated with thermoplastic material. In other example embodiments, cylindrical side wall 210 is formed from a polymer material and/or a biodegradable material, e.g. biodegradable plastic. Optionally, the laminated material is additionally used to thermo-seal upper sealing membrane 220 to flange 212.

In some example embodiments, upper sealing membrane 220 is an aluminum foil, preferably 30 µm - 60 µm thick. Optionally and preferably, the aluminum foil is also laminated, e.g. with thermoplastic material and the laminated side is positioned to face an interior of capsule 200. Upper sealing membrane 220 may alternatively be formed from a polymer material and/or a biodegradable material.

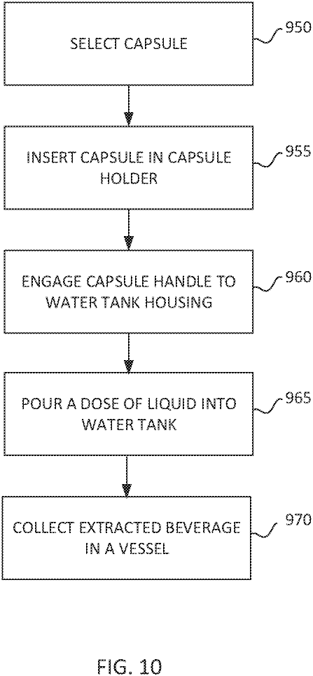

Reference is now made to FIG. 10 showing a simplified flow chart of an example method to prepare a beverage ingredient with a pour over dripper kit in accordance with a first aspect of some example embodiments. A beverage may be prepared by selecting a capsule 200 including a desired beverage ingredient (block 950), placing capsule 200 in capsule holder 300 (block 955) and engaging capsule holder 300 onto water tank housing 100 (block 960). Once engaged, a liquid for forming, e.g. brewing the beverage is added to water tank 110 (block 965) and the extracted beverage is collected in a vessel positioned under water tank 110 (block 970). Optionally and preferably blocks 950 - 970 may be repeated with an additional single use capsule.

### Second Aspect of Some Example Embodiments

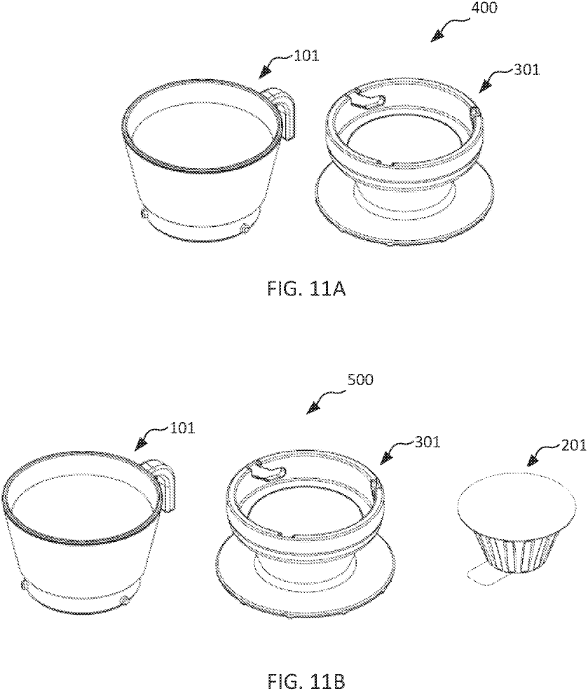

Reference is now made to FIGS. 11A and 11B showing respectively an example pour over dripper kit and an example pour over dripper system, both in accordance with some example embodiments. According to some example embodiments, a pour over dripper kit 400 includes a capsule holder 301 and a water tank 101. Pour over dripper kit 400 is configured for manually preparing a beverage. According to some example embodiments, each of capsule holder 301 and water tank 101 are sized and configured to prepare a beverage with a capsule 201 containing a beverage ingredient. In some example embodiments, capsule 201 includes coffee grounds and kit 400 provides for manually brewing the coffee, e.g. without a coffee machine. Optionally, capsule 201 includes other or additional beverage ingredients, e.g. powdered milk, a sweetener, tea and/or cocoa. Kit 400 together with capsule 201 defines a pour over dripper system 500. Optionally and preferably, capsule 201 is sized to contain a quantity of beverage ingredient suitable for preparing a single serving of a beverage, e.g. a single cup. In some example embodiments, capsule 201 and/or contents within capsule 201 is suitable for preparing a double serving or more than two servings of a beverage, e.g. a pot of a beverage with multiple servings. Optionally and preferably, kit 400 is configured for multiple use. Multiple servings may be prepared with kit 400 by using a new capsule 201 for each additional serving. According to some example embodiments, system 500 is assembled by positioning capsule 201 in capsule holder 301 and then securing water tank 101 onto capsule holder 301.

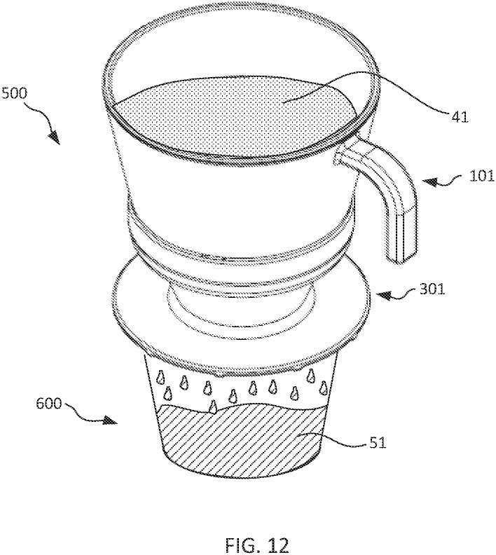

FIG. 12 is an example assembled pour over dripper system in use in accordance with some example embodiments. According to some example embodiments, to prepare a beverage 51, system 500 is positioned over a vessel 600 and liquid 41, e.g. pre-heated water is added to water tank 101. Liquid 41 is configured to controllably drip through a base of water tank 101, and through capsule 201 positioned in capsule holder 301. A bottom of capsule 201 is exposed through capsule holder 301 and the prepared beverage is extracted through a bottom surface of capsule 201 into vessel 600. Vessel 600 may be for example a cup, a mug or a glass.

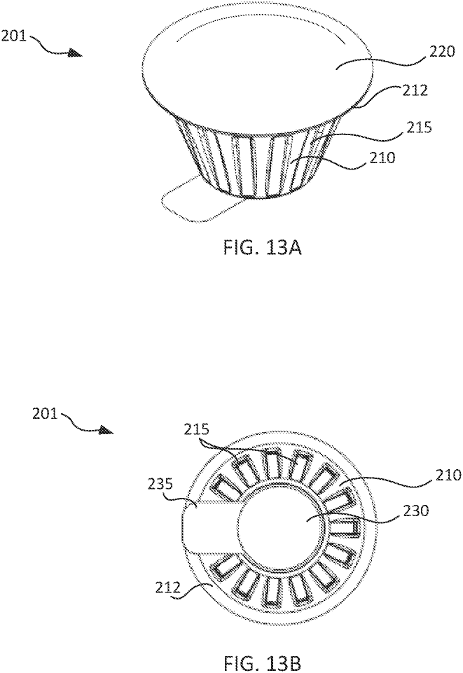

Reference is now made to FIGS. 13A and 13B showing respectively a perspective view and a bottom view of an example sealed capsule in accordance with some example embodiments. In some example embodiments, capsule 201 includes an upper sealing membrane 220 cylindrical side wall 210 and a lower sealing membrane 230. Upper sealing membrane 220, lower sealing membrane 230 and cylindrical side wall 210 together define a closed receptacle configured for containing a beverage ingredient. Optionally and preferably the closed receptacle configuration provides a moisture and air impermeable seal to preserve the beverage ingredient contained in capsule 201. According to some example embodiments, capsule 201 additionally includes a filter and the beverage is configured to be extracted through the filter in capsule 201.

In some example embodiments, cylindrical side wall 210 has a truncated cone shape tapering toward lower sealing membrane 230. In some example embodiments, cylindrical side wall 210 includes a plurality of indentations 215 or protrusions that protrude into an inner volume of capsule 201. Optionally and preferably, cylindrical side wall 210 is aluminum sheet, e.g. with about 201 µm thickness or 60 µm - 210 µm thick. Optionally, the aluminum sheet is laminated with thermoplastic material. Optionally and preferably, the laminated material faces an interior of capsule 201 and provides a barrier between the aluminum and the beverage ingredient contained in capsule 201 or filter housed therein. In other example embodiments, cylindrical side wall 210 is formed from a polymer material and/or a biodegradable material, e.g. biodegradable plastic. Optionally, the laminated material is additionally used to thermo-seal each of upper sealing membrane 220 and lower sealing membrane 230 to capsule 201. Optionally and preferably, upper sealing membrane 220 is sealed to a flange 212 extending out from cylindrical side wall 210.

In some example embodiments, each of upper sealing membrane 220 and lower sealing membrane 230 is an aluminum foil, preferably 30 µm - 60 µm thick. Optionally and preferably, the aluminum foil is also laminated, e.g. with thermoplastic material and the laminated side is positioned to face an interior of capsule 201. Optionally, upper sealing membrane 220 and/or lower sealing membrane 230 is formed from a polymer material and/or a biodegradable material. According to some example embodiments, lower sealing membrane 230 is configured to be removed prior to assembly in system 500. Optionally, lower sealing membrane 230 includes a tab 235 that can be used to pull off (peel off) or otherwise remove lower sealing membrane 230. Optionally, lower membrane 230 is a cap that is fitted, e.g. with a friction fit or screw connection onto a bottom of capsule 201 and is removed by pulling or unscrewing the cap. According to some example embodiments, upper sealing membrane 220 is configured for being pierced when assembled in kit 400 and liquid for preparing the beverage is configured to enter capsule 201 through the pierced openings formed on upper sealing membrane 220.

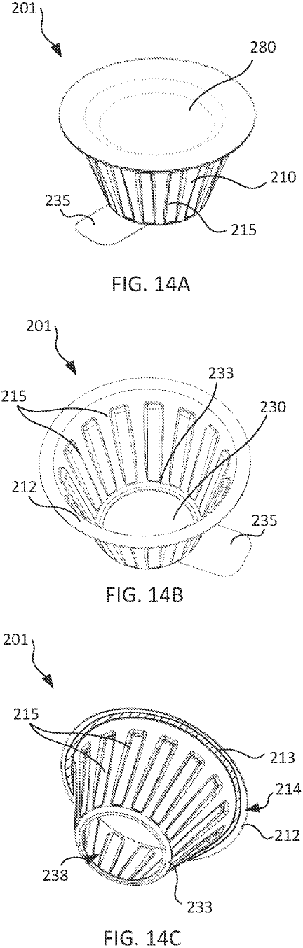

Reference is now made to FIGS. 14A, 14B and 14C showing respectively a perspective view of an example capsule with the upper seal removed, the example capsule with both the upper seal and the filter removed and the example capsule shown without the upper seal and the lower seal and the filter, all in accordance with some example embodiments. According to some example embodiments, capsule 201 includes a filter 280 (FIG. 14A). In some example embodiments, filter 280 is cup or pouch shaped that is open proximal to upper sealing membrane 220. Alternatively, filter 280 is a closed bag, e.g. similar to a tea bag. Optionally, filter 280 may be formed from paper, silk and/or a polymer material. Optionally, filter 280 may be similar to a coffee filter, e.g. similar in shape and make of a coffee filter.

In some example embodiments, capsule 201 includes flange 212 extending outwardly from an upper edge of the cylindrical side wall 210. Optionally, filter 280 is welded, e.g. plastic welded or otherwise fixed onto flange 212. Filter 280 alternatively be welded to an inner face of cylindrical side wall 210. Optionally when filter 280 is in the form of a closed bag, filter 280 may be simply placed in capsule 201 without fixating filter 280 to capsule 201 and may be maintained in the capsule based on its size being larger than the opening through the capsule.

According to some example embodiments, a lower edge of cylindrical side wall 210 extends inwardly to form a rim 233 (FIGS. 14B and 14C). In some example embodiments, lower sealing membrane 230 is welded or otherwise fixed onto rim 233, e.g. an outwardly facing surface of rim 233. According to some example embodiments, rim 233 defines an opening 238 through which a beverage may be extracted from capsule 201. Optionally, filter 280 may be welded, e.g. plastic welded or otherwise fixed to rim 233. Alternatively, when capsule 201 does not include rim 233, lower sealing membrane 230 may be welded out external surface of cylindrical side wall near its lower edge.

Optionally, a bottom face 214 of flange 212 (opposite upper sealing membrane 220) includes a sealant 213 defined to have properties, e.g. hardness and/or elasticity that is suitable for forming a liquid sealed connection with a surface such as a seat of capsule holder 301 when pressed against the seat of the dripper while assembled in kit 400. Optionally, sealant 213 is a polymer, silicon and/or rubber material. Optionally, sealant 213 is coated on bottom face of flange 212. Optionally, a sealant material is also or alternatively included on capsule holder 300.

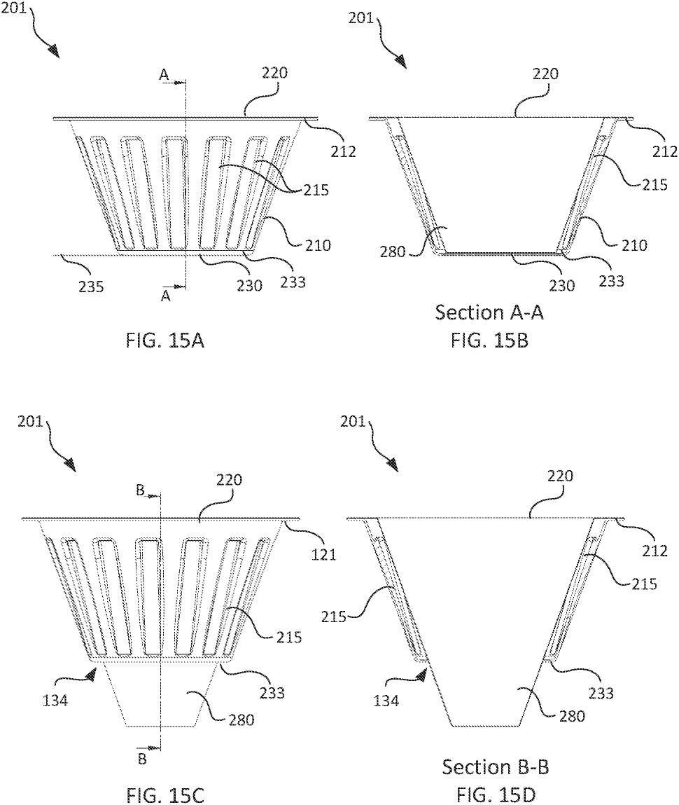

Reference is now made to FIGS. 15A and 15B showing respectively side and cross-sectional views of an example sealed capsule in accordance with some example embodiments. According to some example embodiments, upper sealing membrane 220 is welded, e.g. plastic welded onto flange 212 extending from cylindrical side wall 210. Optionally, filter 280 is a flexible filter, e.g. a bag shaped filter. In some example embodiments, indentations 215 are configured to at least partially displace filter 280 from cylindrical side wall 210. Optionally, displacing filter 280 from cylindrical side wall 210 provides improving air flow through capsule 201 during preparation of the beverage. Optionally, indentations 215 facilitate removing air from capsule 201 as liquid is being introduced therein and thereby improve flow rate through capsule 201 and prevent over brewing and flooding (or clogging) of capsule 201.

Reference is now made to FIGS. 15C and 15D showing respectively side and cross-sectional views of an example capsule with its filter extending through an exposed opening in its bottom face in accordance with some example embodiments. According to some example embodiments, filter 280 is sized to extend through an opening 134 an outer edge of rim 233 or the lower opening when rim 233 is not included. Optionally, filter 280 is flexible and folded within capsule 201 while capsule 201 is sealed with lower sealing membrane 230 and is configured to extend out from capsule 201 through opening 134 during preparation of the beverage. Optionally, the weight of the added liquid during preparation of the beverages pulls filter 280 downwards. Optionally, a height of filter 280 is selected to be 10%- 50% greater than a height of capsule 201. In other example embodiments, filter 280 is fully maintained in capsule 201 during preparation of the beverage.

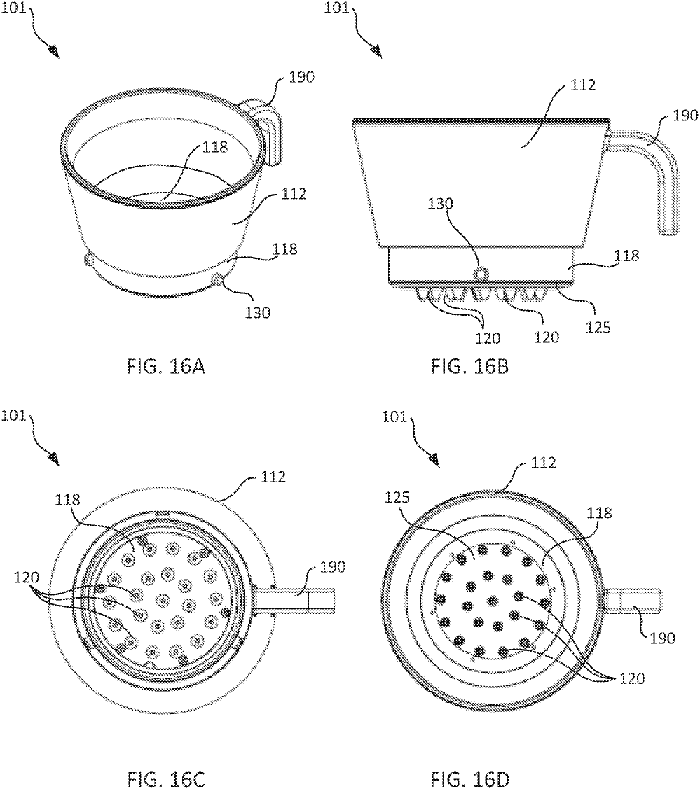

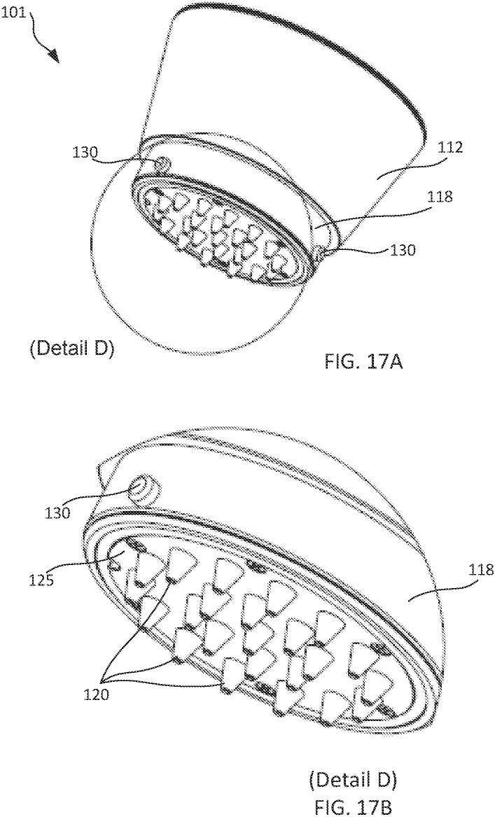

FIGS. 16A,1 6B, 16C and 16D are respectively perspective, side top and bottom views of an example water tank and to FIGS. 17A and 17B showing respectively a perspective and a detailed view of the example water tank, all in accordance with some example embodiments. Water tank 101 includes a cylindrical wall 112 and a base 118 including a bottom surface 125 of water tank 101. According to some example embodiments, base 118 is formed with a plurality and/or an array of nozzles 120 protruding downwardly below bottom surface 125. Optionally nozzles 120 are shaped to taper distal from bottom surface 125, e.g. in the downward direction. Optionally, the tapering facilitates piercing the upper membrane of the capsule. In some example embodiments, nozzles 120 are integral to base 118.

Optionally, water tank 101 includes a handle 190 for comfortable handling of water tank 101. Optionally, water tank 101 includes a lid. In some example embodiments, base 118 includes a connecting element configured to connect and optionally lock to a matching element in capsule holder 301. Optionally the connecting element is one or more pins 130, e.g. 2 pins or 3 pins configured to be a male part of a bayonet mount connector for connecting to capsule holder 301. Optionally, base 118 is recessed with respect to cylindrical wall 112 so that it may securely fit in a seat formed in capsule holder 301. Optionally and preferably, base 118 is annular. In some example embodiments, water tank 101 is a single piece formed by injection molding or three-dimensional printing. In other example embodiments, base 118 is a separate piece that is fixed onto water tank 101, e.g. with one or more screws.

According to some example embodiments, one more parameters of nozzles 120 are defined to provide a desired rate and spatial distribution of liquid flow out of water tank base 118 into the capsule. Optionally, the one more parameters includes number of nozzles 120 in the array, a distribution density of nozzles 120, one or more of an inlet and outlet diameter of nozzles 120 and/or a length of nozzles 120 in a downward direction.

According to some example embodiments, nozzles 120 are configured to actuate a flow rate of 1-2 grams per second and preferably 1.3-1.6 grams per second through capsule 201. Optionally and preferably, nozzles 120 are distributed across base 118 to provide a substantially even spatial distribution of the liquid through the beverage ingredient stored in capsule 201. In some example embodiments, nozzles 120 include 15-30 nozzles, e.g. 20-25 nozzles. Optionally and preferably, an outlet diameter of one or more of nozzles 120, e.g., diameter at its tapered end is 0.5 mm - 0.9 mm, e.g. 0.6 mm -0.7 mm and/or 0.65 mm - 0.7 mm. In some example embodiments, all nozzles 120 are selected to have a same diameter.

Optionally, the distribution density may vary across surface 125, e.g. nozzles 120 may be more densely distributed in a central of base 118 (or surface 125) as compared to a periphery of base 118, e.g. near edges of base 118. Optionally, diameter of nozzles 120, e.g. inlet diameter, outlet diameter or both are selected to vary across surface 125. Optionally, a length of nozzles 120 may vary across base 118. According to some example embodiments, nozzles 120 are additionally configured to pierce upper sealing membrane 220 when assembled in system 500. Optionally a length of nozzles 120 is selected to extend through upper sealing membrane 220 when assembled in system 500 and thereby pierce upper sealing membrane 220.

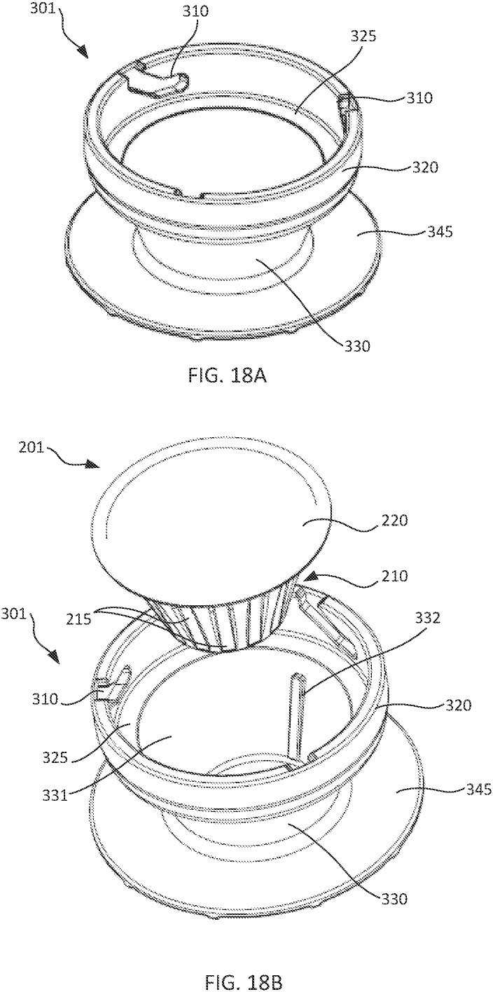

Reference is now made to FIG. 18A is a perspective view of an example capsule holder in accordance with some example embodiments. According to some example embodiments, capsule holder 301 includes a cylindrical wall 230 in which capsule 201 may be received, a supporting structure 345 configured to support system 500 over vessel 600, a collar 320 extending around an upper edge of cylindrical wall 230 configured for receiving base 118 of water tank 101 and a seat 325 extending inwardly from collar 320 and/or upper edge of cylindrical wall 230 and configured for supporting flange 212 of capsule 201. Optionally, capsule holder 301 includes a gasket positioned on seat 325 (and under flange 212) for providing a liquid sealed engagement between flange 212 and seat 325. Optionally, capsule holder 301 includes a gasket or an O-ring positioned on seat 325 for providing the liquid sealed engagement. Optionally, the gasket or the O-ring may be in place or in addition to sealant 213 on the flange of capsule 201.

According to some example embodiments, collar 320 includes a connecting element configured to connect with a matching connecting element, e.g. elements 130 in FIG. 17A, in water tank 101. Optionally, the connecting element is one or more slots 310, e.g. 2 slots or 3 slots configured as a female parts of a bayonet mount connector, e.g. an L-shaped slot configured to receive pin 130 and thereby lock water tank 101 onto capsule holder 301. According to some example embodiments, seat 325 is sized to support flange 212 of capsule 201 and base 118 of water tank 101. In some example embodiments, seat 325 is coated with a sealant material configured to provide a liquid impermeable seal between flange 212 and seat 325 e.g., a polymer, elastomer, silicon, and/or rubber defined to have properties e.g., hardness and/or elasticity suitable for forming a sealed connection with a flange 212 when assembled in kit 500. The coating of sealant material may be instead or in addition to one or more of the gasket and/or O-ring. Cylindrical wall 230 may have a shape similar to cylindrical side wall 210 of capsule 201, e.g. a truncated cone shape. Optionally, cylindrical wall 230 and cylindrical side wall 210 are selected to have a substantially same height.

Reference is now made to FIG. 18B showing a perspective view of an example capsule holder and capsule including a locking feature in accordance with some example embodiments. According to some example embodiments, capsule holder 301 and capsule 201 include a key and lock feature that provides a snug fit of capsule 201 into capsule holder 301 and optionally prevents rotation of capsule 201 in capsule holder 301. In some example embodiments, the lock and key feature includes a bulge 332 in capsule holder 301 that is configured to be received in an indentation 215 of capsule 201. Bulge 332 may be formed on an inner surface 331 of cylindrical side surface 330 and may be sized and shaped to be received any one of indentations 215 in capsule 201. Optionally, capsule holder 301 includes more than one bulge 332. Optionally and preferably bulge 332 and indentations 215 are shaped to facilitate easily inserting and removing capsule 201 in and out of capsule holder 301. In other example embodiments, the lock and key connection between capsule 201 and capsule holder 301 is defined between flange 212 and seat 325, e.g. seat 325 may include a bulge similar to 332 and flange 212 may include matching element configured to receive the bulge.

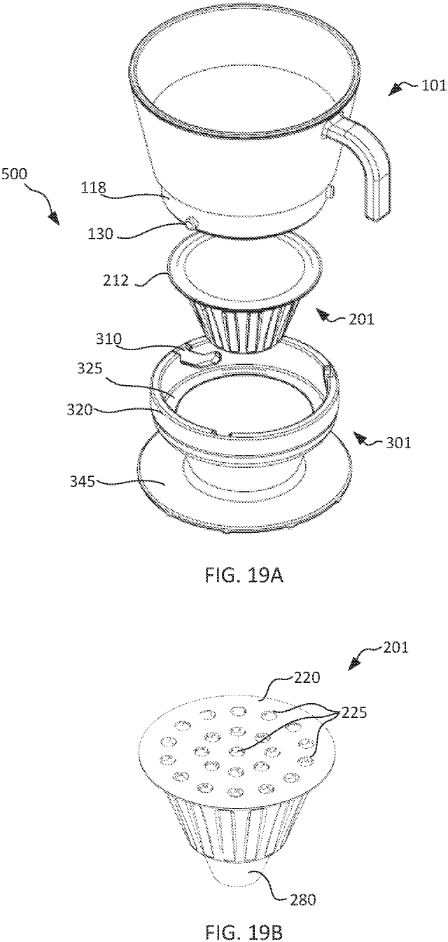

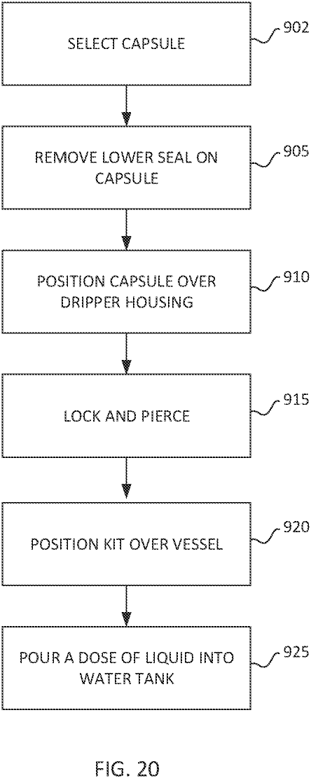

Reference is now made to FIGS. 19A and 19B showing respectively a blow up view of an example pour over dripper system and a pierced capsule and to FIG. 20 showing a simplified flow chart of an example method to prepare a beverage with a pour over dripper kit, all in accordance with some example embodiments. According to some example embodiments, a user selects a desired capsule 201 from a plurality of capsules 201 (block 902). Optionally and preferably, capsules 201 include lower sealing membrane 230. In some example embodiments, lower sealing membrane 230 (see FIG. 13B) is manually removed, e.g. peeled off (block 905) prior to assembling capsule 201 in the pour over dripper kit. After removing lower sealing membrane 230, capsule 201 is placed in capsule holder 301 (block 910). In some example embodiments, seat 325 supports flange 212 of capsule 201 and thereby holds capsule 201 in place. Water tank 101 is then positioned over capsule holder 301 (block 910), e.g. in seat 325. In some example embodiments, when a bayonet mount is used, pins 130 in water tank 101 are aligned with slots 310 in capsule holder 301 for locking water tank 101 in place. Optionally, pins 130 are alternatively included in capsule holder 301 and slots 310 are included in water tank 101. In other example embodiments, water tank 101 and capsule holder 301 includes screw threads and the locking is based on screwing water tank 101 into capsule holder. Optionally, water tank 101 may be locked or fitted into capsule holder 301 with a friction fit or snap fit.

Water tank 101 may then be twisted or otherwise locked onto capsule holder 301. The locking action (or mounting action) concurrently pierces upper sealing membrane 220 with array of nozzles 120 (block 915). In other example embodiments, when a bayonet mount is not used, water tank 101 may be locked or fitted into capsule holder 301 with a friction fit or with a screw motion.

Nozzles 120 may penetrate into upper sealing membrane 220 before reaching the locked position or substantially at the locking position. Optionally, when nozzles 120 penetrate upper sealing membrane 220 before reaching the locked position, further twisting to complete the lock may further tear through upper sealing membrane 220 during the twisting. The larger openings created during twisting may further increase a rate at which air inside capsule 201 may flow out as liquid is introduced into capsule 201.

Optionally and preferably, nozzles 120 of water tank 101 pierce through upper sealing membrane 220 and tear openings 225 therethrough. System 500 including water tank 101, capsule 201 and capsule holder 301 is now assembled and may be positioned over a vessel 600 configured for receiving the prepared beverage (block 920). A dose of liquid for preparing the beverage may be added to water tank 101 (block 925). Optionally, the liquid is preheated water for brewing, e.g. coffee, tea, an infusion and/or cocoa. According to some example embodiments, the dose of liquid may be added to water tank 101 in one shot without the need to use a long thin spout and without the need to slowly pour in a spiral motion. Instead the array of nozzles 120 provide controlling the flow rate and the spread of the liquid into the beverage ingredient stored in capsule 201. After the beverage is prepared, water tank 101 may be disengaged with capsule holder 301 and capsule 201 may be removed and discarded. An additional beverage may be prepared by selecting a new capsule 201 to capsule holder 301 and repeating the steps in block (905) to block (925).

It is noted that although the embodiments of the second aspect have been described to include a water tank 101 that is partially fitted into capsule holder 301, in other example embodiments, capsule holder 301 may alternative be partially fitted into a base 118 of water tank 101 and pin 130 may be positioned on an inner surface of base 118. Optionally, water tank 101 may be supported with a stand as described in FIG. 1. Optionally, capsule holder 301 may include a handle 352 as disclosed in FIG. 1.

### Third Aspect of Some Example Embodiments

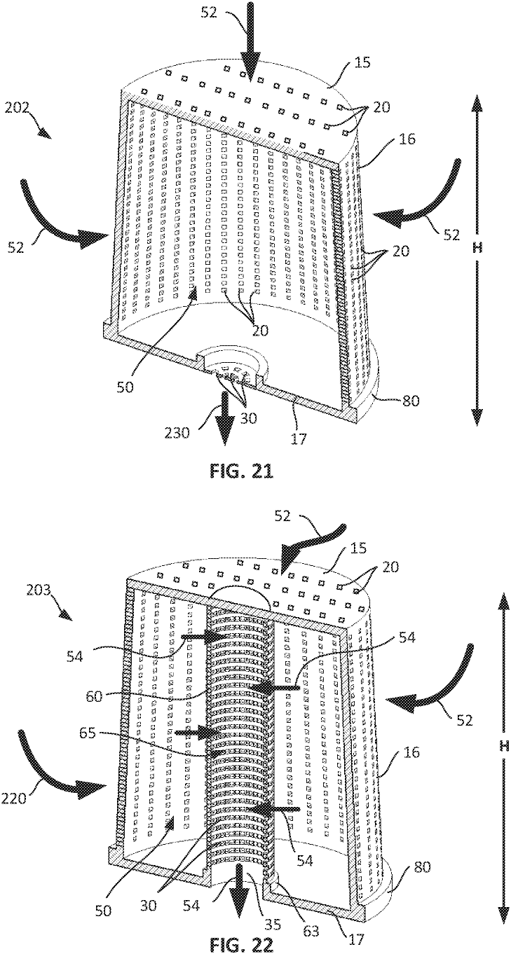

Reference is now made to FIG. 21 showing an example capsule configured for use with a pour over beverage dripper in accordance with some example embodiments. A capsule 202 is configured to contain a beverage ingredient in inner volume 50 of capsule 202. According to some example embodiments, capsule 202 includes a plurality of inlet holes 20, e.g., an array of inlet holes 20, formed on one or more external surfaces of capsule 202. Optionally, the beverage ingredient is ground coffee and plurality of holes 20 is configured to prevent leakage of the coffee granules. According to some example embodiments, capsule 202 additionally includes one or more outlet holes 30, e.g., an array of outlet holes 30, through which liquid that penetrated into capsule 202 may be expelled. According to some example embodiments, inlet holes 20 and outlet holes 30 are sized to provide functionality of a filter that is configured to contain the beverage ingredient therein while allowing a liquid for preparing the beverage to penetrate therethrough. Optionally, an array of outlet holes 30 are spread substantially across sealed lid 17. Capsule 202 including the array of inlet holes 20 and the one or more outlet holes 30 is a filter. Optionally, inlet holes 20 and outlet holes 30 are of the same size.

In some example embodiments, capsule 202 has a truncated cone shape and includes an upper facing base 15, a bottom facing sealed lid 17 and a surrounding wall 16 extending along a height H from sealed lid 17 to upper facing base 15. In some example embodiments, an array of inlet holes 20 may be formed on surrounding wall 16 and/or may also be formed on upper facing base 15. One or more outlet holes 30 may be formed on sealed lid 17. According to some example embodiments, liquid that is poured on capsule 202 penetrates through array of inlet holes 20 into inner volume 50 configured to contain a beverage ingredient and then flows out of capsule 202 (flow 54) through outlet holes 30. Outlet holes 30 may be positioned on sealed lid 17 that is to be directed toward a glass, mug, cup, vacuum flask or carafe.

According to some example embodiments, array of inlet holes 20 is spread along surrounding wall 16 and optionally across upper facing base 15. In some example embodiments, surrounding wall 16 may be impermeable to liquid and inlet holes 20 may only be positioned across upper facing base 15. The spread of inlet holes 20 across a width and height H of capsule 202 provides a relatively large surface area through which a liquid can penetrate therein from a plurality of directions and heights. According to some example embodiments, the relatively large surface area and multiple direction through which a liquid may concurrently penetrate enhances the penetration and the uniformity of the liquid flow through the beverage ingredient. As compared to pour over coffee drippers in which all the preheated water first contacts an upper surface of the ground coffee and then flows downwards, flow through capsule 202 may enable concurrent penetration of water at all levels of a ground coffee bed within capsule 202.

In other example embodiments, capsule 202 may have alternate shapes. Optionally, capsule 202 may be dome shaped, e.g., surrounding wall 16 and upper facing base 15 may be integrated to a smooth surface forming a dome shape. Similarly other polygonal shapes may be contemplated, e.g., cylindrical, cuboid, hexagonal, pyramid shape.

According to some example embodiments, a rate of water flow 52 into capsule 202 may be regulated based on the number inlet holes 20. More inlet holes 20 may provide a higher rate of penetration as compared to fewer inlet holes 20 that provide a lower rate of penetration. Similarly, a rate of water flow 54 out of capsule 202 may be regulated based on the number outlet holes 30. More outlet holes 30 may provide a higher rate of flow as compared to fewer outlet holes 30 that provide a lower rate of flow. According to some example embodiments, a ratio between number of inlet holes 20 and number out outlet holes 30 is defined. In some example embodiments, based on the ratio, a brewing time for brewing a beverage is regulated. Optionally, the number inlet holes 20, the number of outlet holes 30 and/or the ratio between those numbers is defined to effect 3-4 minutes of contact between the liquid and the beverage ingredient.

According to some example embodiments, capsule 202 additionally includes a flange 80 extending out from an outer surface or edge of capsule 202. According to some example embodiments, a rim of flange 80 is configured to engage a pour over dripper housing with a sealed engagement. Optionally, flange 80 may snap into a ring formed in a dedicated pour over dripper housing. Optionally, flange 80 may include screw threads and may be configured to screw into a neck portion formed in the pour over dripper housing. In some example embodiments, flange 80 is or includes an elastic and/or flexible material or is coated with an elastic and/or flexible material that is configured to provide and/or improve the sealed engagement with the neck portion of pour over dripper housing. In some example embodiments, flange 80 extends out from a sealed lid 17 of capsule 202. It is noted that although sealed lid 17 is depicted as being flat, other shapes are contemplated. Optionally, sealed lid 17 may have an inverted dome shape or other concave shape. According to some example embodiments, plurality of holes 20 are formed on a surface of capsule 202 above flange 80 and one or more outlet holes 30 are formed on a surface of capsule 202 that is below flange 80 or otherwise isolated from plurality of holes 20 based on flange 80.

In some example embodiments, sealed lid 17 is fixedly attached to surrounding wall 16 after filling capsule 202 with a beverage ingredient. Sealed lid 17 may be formed from a same or different material than surrounding wall 16 and upper facing base 15. Flange 80 may integral to surrounding wall 16. Optionally, sealed lid 17 may be an aluminum foil coated with a polymer coating or lacquer, e.g. a thermoplastic lacquer that provides for thermo-sealing sealed lid 17 to flange 80. Optionally, sealed lid 17 may be made from a polymer material. In another example, flange 80 may be integral to sealed lid 17 and surrounding wall 16 may be fitted into flange 80. Upper facing base 15 may be integral with surrounding wall 16 and may be formed with an aluminum sheet, e.g. in a drawing process. In other example embodiments, upper facing base 15 and surrounding wall 16 may be formed from a polymer material, e.g. in a molding process. According to some example embodiments, upper facing base 15 and surrounding wall 16 form a rigid structure and/or are made from a rigid material. Sealed lid 17 may be made from a flexible or a rigid material.

In other example embodiments, surrounding wall 16 may include a structural feature configured to engage a pour over dripper housing with a sealed engagement. The structural feature may be an elastic or elastomer coating or ring positioned on surrounding wall 16 or screw threads formed on a portion of surrounding wall 16.

Reference is now made to FIG. 22 showing an example capsule with an enclosed filter also configured for use with a pour over beverage dripper in accordance with some example embodiments. According to some example embodiments, capsule 203 includes array of inlet holes 20 formed on one or more external surfaces of capsule 203 and includes an enclosed outlet filter 60 including an array of outlet holes 30. According to some example embodiments, outlet filter 60 extends along a height H of capsule 203 or a portion of height H, e.g. 70%-100% of height H or 80%-90% of height H and includes array of outlet holes 30 spread along a substantially entire surface of outlet filter 60. Optionally, outlet filter 60 defines an inner volume 65. In some example embodiments, an outlet 35 through sealed lid 17 of capsule 203 extends out from inner volume 65. In some example embodiments, outlet filter 60 is cylindrical. Optionally, outlet filter 60 is positioned to be concentric with surrounding walls 16.

According to some example embodiments, a beverage ingredient is configured to be contained within volume 50 between surrounding wall 16 and outlet filter 60. Liquid for preparing a beverage may flow into capsule 203 from a plurality of direction, e.g. flow 52, penetrate volume 50 including the beverage ingredient, and may be expelled through outlet holes 30 in outlet filter 60 and outlet 35. Outlet 35 may be directed toward a glass, mug, cup, vacuum flask or carafe.

According to some example embodiments, a rate of water flow 52 into capsule 202 may be regulated based on the number inlet holes 20 as described in reference to FIG. 21. Similarly, a rate of water flow 54 out of capsule 202 may be regulated based on the number outlet holes 30 and/or a diameter of outlet filter 60.

As discussed in reference to FIG. 21, sealed lid 17 may be fixedly attached to surrounding wall 16 after filling capsule 202 with a beverage ingredient. Optionally, outlet filter 60 is integral with sealed lid 17 or is fitted into a slot or frame 63 formed in sealed lid 17. Sealed lid 17 may be formed from a same or different material than surrounding wall 16 and upper facing base 15. In some example embodiments, outlet filter 60 is integral with upper facing base 15 or is fitted into a slot or frame formed in upper facing base 15. Filter 60 may be formed with a same or different material than the material of external surface of capsule 203.

In some example embodiments, capsule 202 is packaged, e.g. fitted into another capsule that has a same shape or a similar shape to capsule 202 both without inlet holes 20 and outlet holes 30. Capsule 202 may be removed from the packaging prior to use. In other example capsule 202 may be packaged in a sealed aluminum bag or other container.

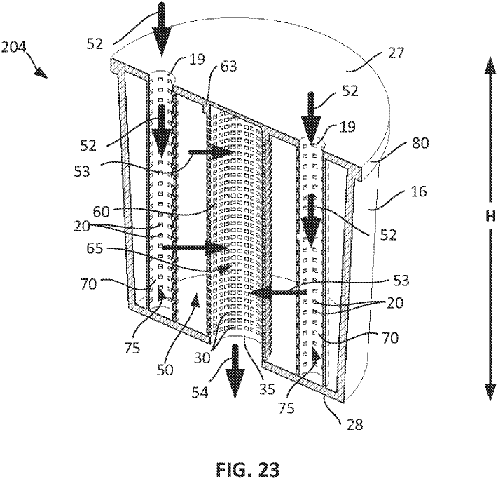

Reference is now made to FIG. 23 showing an example capsule with a plurality of enclosed filters also configured for use with a pour over beverage dripper in accordance with some example embodiments. According to some example embodiments, capsule 204 includes one or more inlet filters 70 and an outlet filter 60 (or optionally more than one outlet filter 60). According to some example embodiments, one or more inlet filters 70 as well as outlet filter 60 are enclosed within a volume 50 of capsule 204. According to some example embodiments, inlet filters 70 extending along a height H of capsule 204 and includes plurality of holes 20. Each of filters inlet 70 may define an inner volume 75. Optionally, an inlet 19 through upper facing base 15 of capsule 204 associated with each of filters 70 extends into inner volume 75. Optionally, inlet filters 70 are cylindrical.

According to some example embodiments, surrounding walls 16 are solid, e.g. impermeable to liquid and inlet flow 52 into capsule 204 is via one or more inlets 19. According to some example embodiments, the beverage ingredient is contained in volume 50 between surrounding wall 16, inlet filters 70 and outlet filter 60. According to some example embodiments, water flow 52 into inlet filters 70 flows out into the beverage ingredient through plurality of holes 20 and then is expelled from capsule 204 through filter 30 and outlet 35.

In some example embodiments, capsule 204 has a truncated cone shape and includes an upper sealed lid 27, a bottom facing base 28 and a surrounding wall 16 extending along a height H from bottom facing base 28 to sealed lid 27. In some example embodiments, capsule 202 is packaged, e.g. fitted into another capsule that has a same or a similar shape to capsule 202 both without inlet holes 20 and outlet holes 30. Capsule 202 may be removed from the packaging prior to use. In other example capsule 202 may be packaged in a sealed aluminum bag or other container.

In some example embodiments, flange 80 extends out from sealed lid 27 of capsule 204 or extends out from an edge of surrounding wall 16 proximal to sealed lid 27. In some example embodiments, sealed lid 27 is fixedly attached to surrounding wall 16 after filling capsule 204 with a beverage ingredient. Sealed lid 27 may be formed from a same or different material than surrounding wall 16 and/or sealed lid 17. Flange 80 may integral to surrounding wall 16. Optionally, sealed lid 27 may be an aluminum foil coated with a polymer coating or lacquer, e.g. a thermoplastic lacquer that provides for thermo-sealing sealed lid 27 to flange 80. In another example, flange 80 may be integral to sealed lid 27 and surrounding wall 16 may be fitted into flange 80. Bottom facing base 28 may be integral with surrounding wall 16 and may be formed with an aluminum sheet, e.g. in a drawing process. In other example embodiments, bottom facing base 28 and surrounding wall 16 may be formed from a polymer material, e.g. in a molding process. According to some example embodiments, bottom facing base 28 and surrounding wall 16 form a rigid structure and/or are made from a rigid material. Sealed lid 27 may be made from a flexible or a rigid material.

In other example embodiments, surrounding wall 16 may include a structural feature configured to engage a pour over dripper housing with a sealed engagement. The structural feature may be an elastic or elastomer coating or ring positioned on surrounding wall 16 or screw threads formed on a portion of surrounding wall 16.

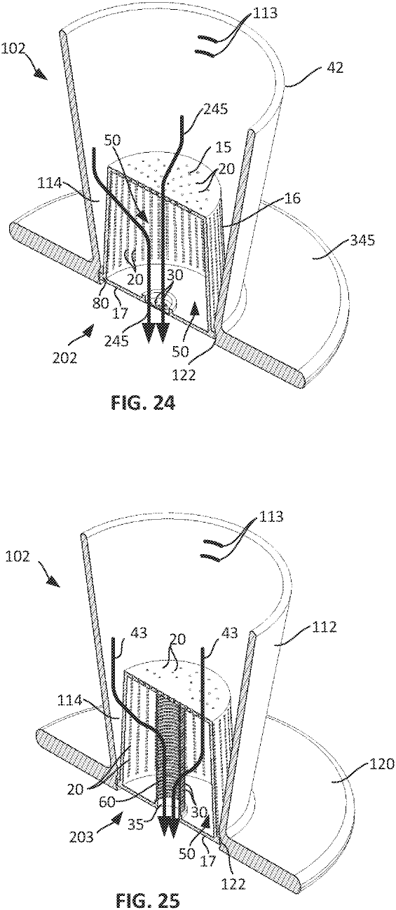

Reference is now made to FIG. 24 is a perspective cross sectional view of an example capsule and an example pour over dripper housing in accordance with some example embodiments. According to some example embodiments, a pour over dripper housing 102 includes a cup shaped enclosure with an open bottom configured to receive capsule 202. The enclosure may be defined by one or more walls 112, e.g. one surrounding wall. In some example embodiments, surrounding walls 112 may be tapered and may optionally look like a funnel. The open bottom may include and/or may form a neck portion 122. According to some example embodiments, flange 80 of capsule 202 is configure to engage neck portion 122 and form a sealed connection that is impermeable to liquid. According to some example embodiments, neck portion 122 is configured to repeatedly form a sealed engagement with capsule 202, e.g. the sealed connection between neck portion 122 and capsule 202 may be broken and then formed again with a same or different capsule 202. Neck portion 122 may include a gasket or may be lined with an elastic, elastomer and/or a flexible material that provides forming a sealed engagement with capsule 202. Optionally, neck portion 122 is formed with screw threads that match screw threads on flange 80 of capsule 202. Optionally, neck portion 122 is configured to form a sealed engagement with a structural feature of capsule 202 other than flange 80. According to some example embodiments, upper facing base 15 and surrounding wall 16 of capsule 202 are contained within the enclosure defined by walls 112 while capsule 202 is attached to pour over dripper housing 102. According to some example embodiments, a space 114 between surrounding wall 16 of capsule 202 and walls 112 of pour over dripper housing 102 allows liquid poured into pour over dripper housing 102 to penetrate through surrounding walls 16 as well as through upper facing base 15. In some example embodiments, the space 114 is defined by an upwardly tapering shape of capsule 202 and a downwardly tapered shape of wall 112. Optionally, walls 112 are configured to taper toward flange 80 so that substantially all the liquid poured into pour over dripper housing 102 is directed toward capsule 202 and is not collected around capsule 202. In other example embodiments, walls 16 of capsule 204 are configured to form the sealed engagement to neck portion 122. According to some example embodiments, housing 102 additionally includes a flange 345 that extends from walls 112. Flange 345 may be configured to be supported by an upper edge of a glass, mug, cup, vacuum flask or carafe and to align outlet holes 30 with an inner volume of the glass, mug, cup, vacuum flask or carafe. According to some example embodiments, liquid, e.g. preheated water is poured into pour over dripper housing 102. Optionally, all of the required liquid may be poured in one go. Liquid contained within surrounding walls 112 may penetrate through array of inlet holes 20 in capsule 202, immerse beverage ingredient in inner volume 50 and pour out through plurality of outlet holes 30 after being immersed with the beverage ingredient. Optionally, capsule 202 provides draining liquid through a capsule including capsule 202 and the beverage ingredient within 3-4 minutes. Optionally, liquid contained in pour over dripper housing may flow in flow direction 245.

In other example embodiments, surrounding wall 16 may include a structural feature configured to engage neck portion 122 with a sealed engagement instead of flange 80. The structural feature may be an elastic or elastomer coating or ring positioned on surrounding wall 16 or screw threads formed on a portion of surrounding wall 16.

In some example embodiments, pour over dripper housing 102 is configured for multiple use and capsule 202 is configured for one time use. Pour over dripper housing 102 may be formed from any material, e.g. a polymer material, ceramic material, metal material, paper or wood. According to some example embodiments, pour over dripper housing is sized to contain a full serving of liquid for making the beverage. Optionally, pour over dripper housing includes one or more marks 113 that indicate the amount of water required to prepare specific beverages.

Reference is now made to FIG. 25 is a perspective cross sectional view of an example capsule including an enclosed filter and an example pour over dripper housing in accordance with some example embodiments. According to some example embodiments, a same or similar pour over dripper housing may be used with capsule 203. According to some example embodiments, a capsule 203 may be fitted onto a neck portion 122 of pour over dripper housing 102 as described in reference to FIG. 24. Liquid contained within enclosure defined by walls 112 may penetrate through plurality of holes 20 in capsule 203, immerse beverage ingredient in inner volume 50, flow through plurality of holes 30 and pour out from capsule 203 through outlet 35. In capsule 203, the prepared beverage is separated from the beverage ingredient through array of holes 30 spanning over a height of capsule 203. This is different than flow through capsule 202 (FIG. 24) where the prepared beverage separates from the beverage ingredient as it passes across sealed lid 17. Optionally, liquid contained in pour over dripper housing may flow in flow direction 242.

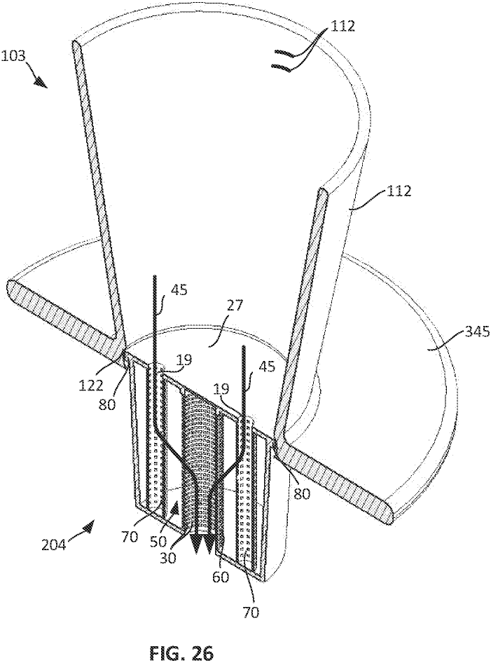

Reference is now made to FIG. 26 is a perspective cross sectional view of an example capsule including a plurality of enclosed filters and an example pour over dripper housing in accordance with some example embodiments.

According to some example embodiments, a pour over dripper housing 103 includes a cup shaped enclosure with an open bottom configured to receive capsule 204. The enclosure may be defined by one or more walls 112, e.g. one surrounding wall. In some example embodiments, surrounding walls 112 may be tapered and may optionally look like a funnel. The open bottom may include and/or may form a neck portion 122. According to some example embodiments, flange 80 of capsule 204 is configured to engage neck portion 122 and form a sealed connection that is impermeable to liquid. Neck portion 122 may include a gasket or may be lined with an elastic, elastomer and/or a flexible material that provides forming a sealed engagement with capsule 204. Optionally, neck portion 122 is formed with screw threads that match screw threads on flange 80 of capsule 202. In other example embodiments, walls 16 of capsule 204 are configured to form the sealed engagement to neck portion 122.

According to some example embodiments, upper sealed lid 27 seals the open bottom of pour over dripper housing 103 and surrounding wall 16 with bottom facing base 28 of capsule 202 extend below pour over dripper housing 103. Optionally, walls 112 are configured to taper toward flange 80 so that substantially all the liquid poured into pour over dripper housing 103 is directed toward capsule 204 and is not collected around capsule 204.

According to some example embodiments, housing 103 additionally includes a flange 345 that extends from walls 112. Flange 345 may be configured to be supported by an upper edge of a glass, mug, cup, vacuum flask or carafe and to align capsule 204 with an inner volume of the glass, mug, cup, vacuum flask or carafe. According to some example embodiments, liquid, e.g. preheated water is poured into pour over dripper housing 103. Optionally, the liquid may be poured in one go. Liquid contained within surrounding walls 112 may penetrate through plurality of inlet holes 19 in capsule 204, immerse beverage ingredient in inner volume 50 and pour out through plurality of outlets 30 after being filtered through filter 60. Optionally, liquid contained in pour over dripper housing may flow in flow direction 45.

In some example embodiments, pour over dripper housing 103 is identical to pour over dripper housing 102. In some example embodiments, pour over dripper housing 103 is configured for multiple use and capsule 204 is configured for one time use. Optionally, housing 103 may also be configured for one time use. Pour over dripper housing 103 may be formed from any material, e.g. a polymer material, ceramic material, metal material, paper or wood. According to some example embodiments, pour over dripper housing is sized to contain a full serving of liquid for making the beverage. Optionally, pour over dripper housing includes one or more marks that indicate the amount of water required to prepare specific beverages.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention.

Structural features of the pour over dripper kit described with respect to any of the aspects of the invention can be used with embodiments of the first, second or third aspects of the invention. For example, details on materials of the capsule and/or sealing element provided regarding embodiments of the first, second or third aspects of the invention can be used in embodiments of other aspects of the invention as well. Also, the nozzles and/or filter described with respect to embodiments of the second aspect of the invention can be used with embodiments of the first aspect of the invention and vice versa.

Certain features described in the context of various embodiments are not to be considered essential features of those embodiments, unless the embodiment is inoperative without those elements. For example, the stand described with respect to embodiments of the first aspect of the invention is not an essential feature as the pour over dripper kit can also be positioned on top of a vessel.

In addition, any priority document(s) of this application is/are hereby incorporated herein by reference in its/their entirety.

What is claimed is:

1. A pour over dripper kit configured for extracting a beverage through a single use capsule and into a vessel, the kit comprising:
a water tank including a base surface formed with a plurality of nozzles extending downwardly from said base surface, said water tank configured for receiving a liquid and controllably dispensing the liquid for preparing the beverage for preparing the beverage; and
a capsule holder configured to be fixedly engaged with said water tank and to support the single use capsule under said base surface while fixedly engaged, wherein the capsule holder includes at least one bottom opening through which the beverage is extracted;
wherein said plurality of nozzles are sized and positioned to pierce the single use capsule and to direct flow of said liquid into the single use capsule with gravitational flow while said water tank is engaged with said capsule holder.

2. The kit of claim 1, wherein said plurality of nozzles is configured to regulate rate of flow through the single use capsule to a flow rate of 1.3-1.6 grams of liquid per second.

3. The kit of claim 1, wherein said capsule holder comprises a seat with a structural feature configured to repeatedly form a liquid impermeable seal with a flange of the single use capsule, said flange extending outwardly from a side wall of the single use capsule.

4. The kit of claim 3, further comprising at least one from a group consisting of a gasket mounted on said seat and an elastic or elastomer material coated on said seat and configured to provide said liquid impermeable seal with the single use capsule.

5. The kit of claim 1, wherein said water tank includes an air vent through which air in the single use capsule can escape as said liquid is directed into the single use capsule.

6-7. (canceled)

8. The kit of claim 1, wherein said capsule holder includes a piercing structure configured for rupturing a bottom surface of the single use capsule through which the beverage is to be extracted.

9. The kit of claim 8, wherein said capsule holder includes a capsule housing and an outer housing wherein said capsule housing is fitted into said outer housing with a slidable connection and wherein said outer housing includes a plug configured to plug the at least bottom opening.

10. The kit of claim 9, wherein a lower rim of said water tank is configured to push said outer housing downwards to release said plug as the capsule holder is being mounted onto the water tank housing based on the slidable connection.

11. (canceled)

12. A single use capsule adapted for containing a beverage ingredient for use in making a beverage with a pour over dripper kit, the single use capsule comprising:
a cylindrical side wall encompassing a volume for containing the beverage ingredient and defining an upper opening encompassed by an upper edge of said cylindrical side wall through which a liquid is configured to be received and a lower opening encompassed by a lower edge of said cylindrical side wall through which the beverage is configured to be extracted;
a flange extending outwardly from the upper edge of said cylindrical side wall;
a filter at least partially enclosed in the single use capsule and configured for filtering the beverage extracted through said lower opening; and
an upper sealing membrane welded to said flange and configured to seal a top of the single use capsule, said upper membrane being configured for being pierced during preparation of the beverage.

13. The single use capsule of claim 12, wherein a bottom face of flange includes a sealant configured to form a liquid sealed connection with a surface on which said flange is mounted.

14. The single use capsule of claim 12, further comprising a lower sealing membrane configured to seal said lower opening and for being manually removed prior to use with the pour over dripper kit.

15. The single use capsule of claim 12, wherein said filter is sized to extend out from said lower opening and wherein a portion of said filter that extends out is 10% - 50% of a height of said filter.

16. The single use capsule of claim 12, wherein said filter is one or both of:
(a) welded to said cylindrical side wall, said flange and/or a rim extending inwardly from said lower edge of said cylindrical side wall; and
(b) pouched shaped and is formed from pliable material.

17. (canceled)

18. The single use capsule of claim 12, wherein the beverage ingredient is ground coffee beans.

19-21. (canceled)

22. A single use capsule for use with a pour over dripper housing, the single use capsule comprising:
one or more walls defining a volume configured to contain a beverage ingredient;
an array of preformed inlet holes through which a liquid is configured to be received in the volume; and
an array of preformed outlet holes through which a prepared beverage is configured to be extracted from the volume, wherein the array of preformed outlet holes is other than the array of preformed inlet holes and displaced therefrom.

23. The single use capsule of claim 22, wherein the one or more walls includes a cylindrical wall extending from a base wall and wherein the array of preformed inlet holes is spread across one or more of the base wall and the cylindrical wall.

24. The single use capsule of claim 23, wherein the array of preformed outlet holes is on a lid wall opposite the base wall, wherein the lid wall is one of the one or more walls.

25. The single use capsule of claim 22, wherein the array of preformed outlet holes is an outlet filter positioned within the volume, and further comprising an outlet through which the prepared beverage is expelled out from the single use capsule, wherein the outlet filter extends along at least a portion of a height of the single use capsule, and wherein the outlet filter has a cylindrical shape defining an inner volume and wherein the outlet extends from the inner volume of the outlet filter.

26. The single use capsule of claim 22, wherein the array of preformed inlet holes is at least one inlet filter positioned within the volume, wherein the at least one inlet filter is positioned to receive liquid through at least one inlet on one or more walls of the single use capsule, wherein the inlet filter extends along at least a portion of a height of the single use capsule.

27. The single use capsule of claim 26, wherein the array of preformed outlet holes is an outlet filter positioned within the volume, and further comprising an outlet through which the prepared beverage is expelled out from the single use capsule, wherein the outlet filter extends along at least a portion of a height of the single use capsule and wherein the outlet filter has a cylindrical shape defining an inner volume and wherein the outlet extends from the inner volume of the outlet filter.

28. (canceled)
